(19) United States
(12) Patent Application Publication
(10) Pub. No.: US 2025/0203071 A1
(43) Pub. Date: Jun. 19, 2025

(54) ON SAO AND CCSAO

(71) Applicants: Douyin Vision Co., Ltd., Beijing (CN); Bytedance Inc., Los Angeles, CA (US)

(72) Inventors: Yang Wang, Beijing (CN); Kai Zhang, San Diego, CA (US); Wenbin Yin, Beijing (CN); Li Zhang, San Diego, CA (US)

(21) Appl. No.: 19/064,222

(22) Filed: Feb. 26, 2025

Related U.S. Application Data
(63) Continuation of application No. PCT/CN2023/115178, filed on Aug. 28, 2023.

(30) Foreign Application Priority Data
Aug. 26, 2022 (WO) PCT/CN2022/115132

(51) Int. Cl. H04N 19/117; H04N 19/186; H04N 19/70

(52) U.S. Cl. CPC H04N 19/117; H04N 19/186; H04N 19/70

(57) ABSTRACT

A mechanism for processing video data is disclosed. The mechanism includes determining parameters for a sample adaptive offset (SAO) filter for a video unit, where the parameters are selected from an explicitly signaled set, or a predefined set, or an adaptive set, and where the adaptive set is derived based on parameters from one or more video units coded before the video unit. A conversion is performed between a visual media data and a bitstream based on the SAO filter.

### CROSS-REFERENCE TO RELATED APPLICATIONS

This application is a continuation of International Patent Application No. PCT/CN2023/115178, filed on Aug. 28, 2023, which claims the priority to and benefits of International Patent Application No. PCT/CN2022/115132 filed on Aug. 26, 2022. The aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining parameters for a sample adaptive offset (SAO) filter; and performing a conversion between a visual media data and a bitstream based on the SAO filter.

A second aspect relates to an apparatus for processing video data comprising: a processor; and a non-transitory memory with instructions thereon, wherein the instructions upon execution by the processor, cause the processor to perform any of the preceding aspects.

A third aspect relates to a non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining parameters for a sample adaptive offset (SAO) filter; and generating the bitstream based on the determining.

A fifth aspect relates to a method for storing bitstream of a video comprising: determining parameters for a sample adaptive offset (SAO) filter; generating the bitstream based on the determining; and storing the bitstream in a non-transitory computer-readable recording medium.

A sixth aspect relates to a method, apparatus or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRA WINGS

For a more complete understanding of this disclosure, reference is now made to the following brief description, taken in connection with the accompanying drawings and detailed description, wherein like reference numerals represent like parts.

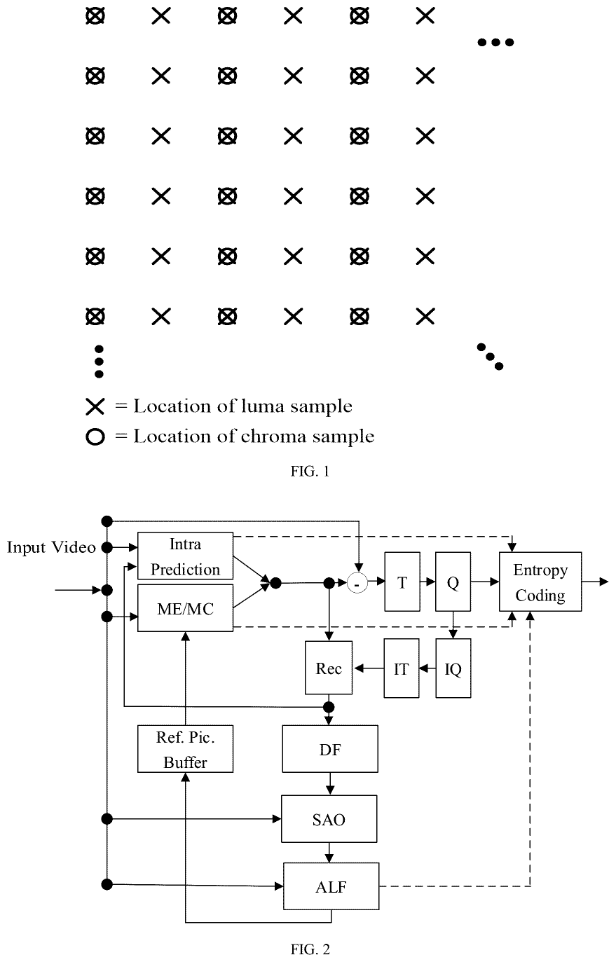

FIG. 1 illustrates an example of nominal vertical and horizontal locations of 4:2:2 luma and chroma samples in a picture.

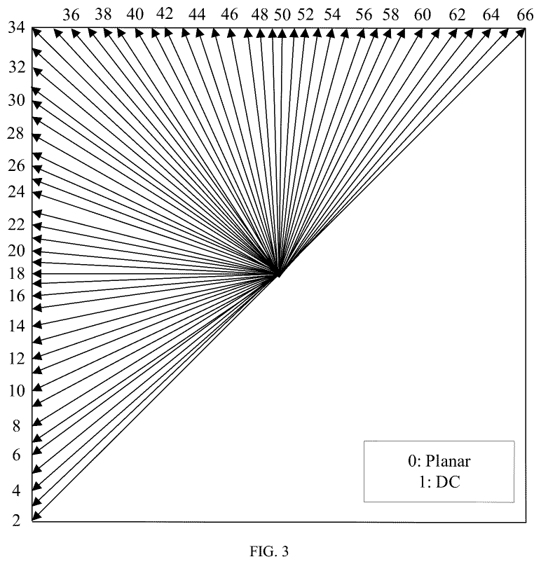

FIG. 2 illustrates an example encoder block diagram.

FIG. 3 illustrates an example of 67 intra prediction modes.

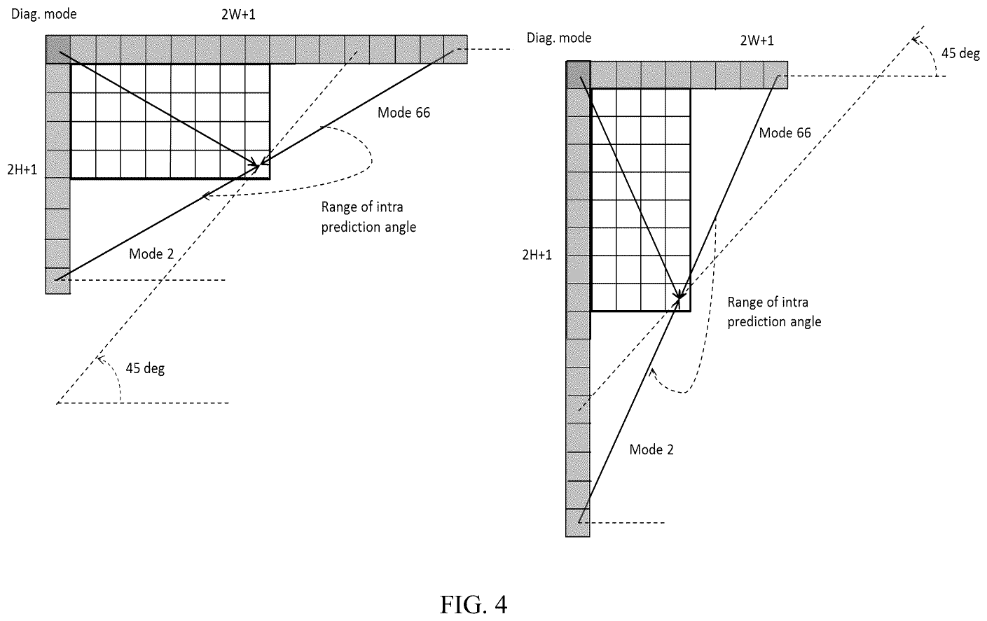

FIG. 4 illustrates an example of reference samples for wide-angular intra prediction.

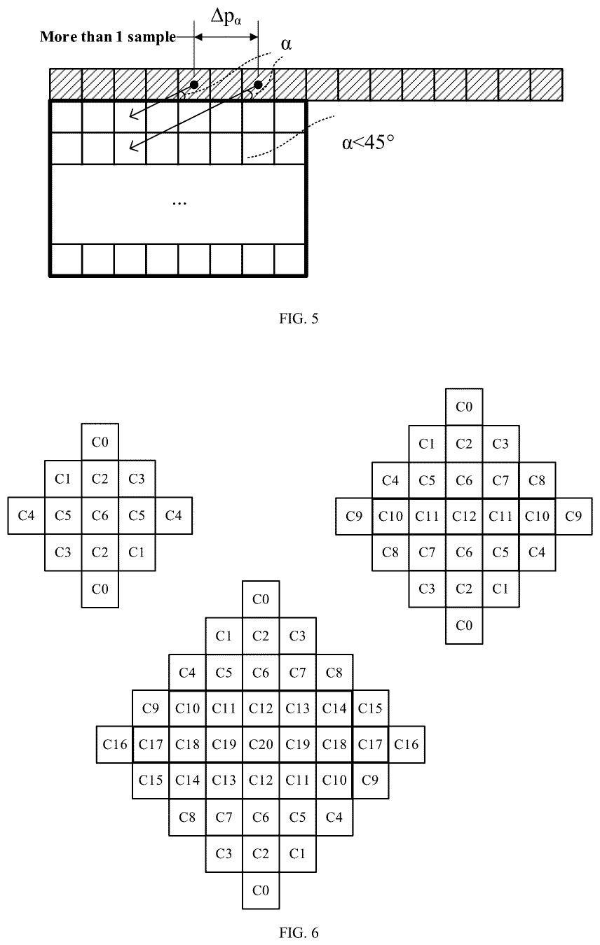

FIG. 5 illustrates an example problem of discontinuity in case of directions beyond 45°.

FIG. 6 illustrates an example of adaptive loop filter (ALF) filter shapes, such as chroma: 5×5 diamond and luma: 7×7 diamond.

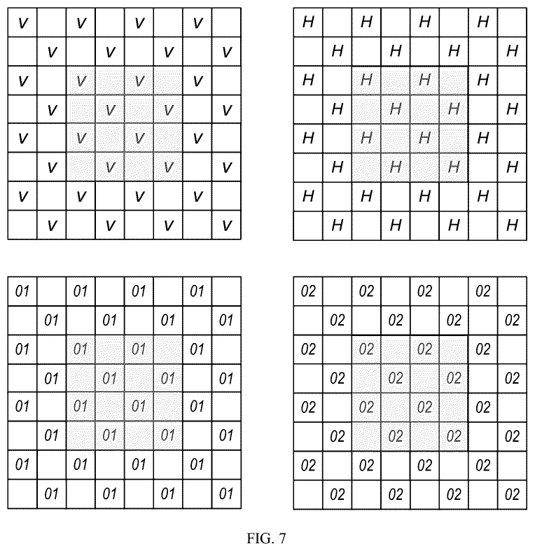

FIG. 7 illustrates an example of a subsampled Laplacian calculation.

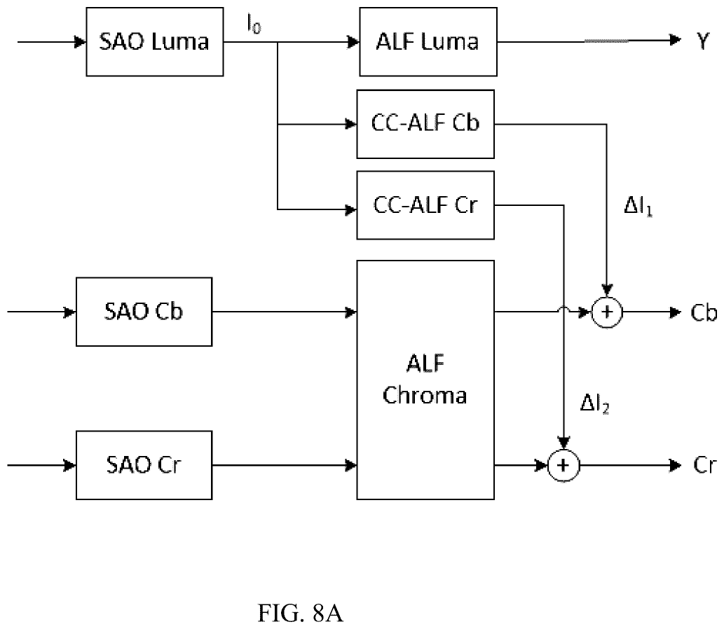

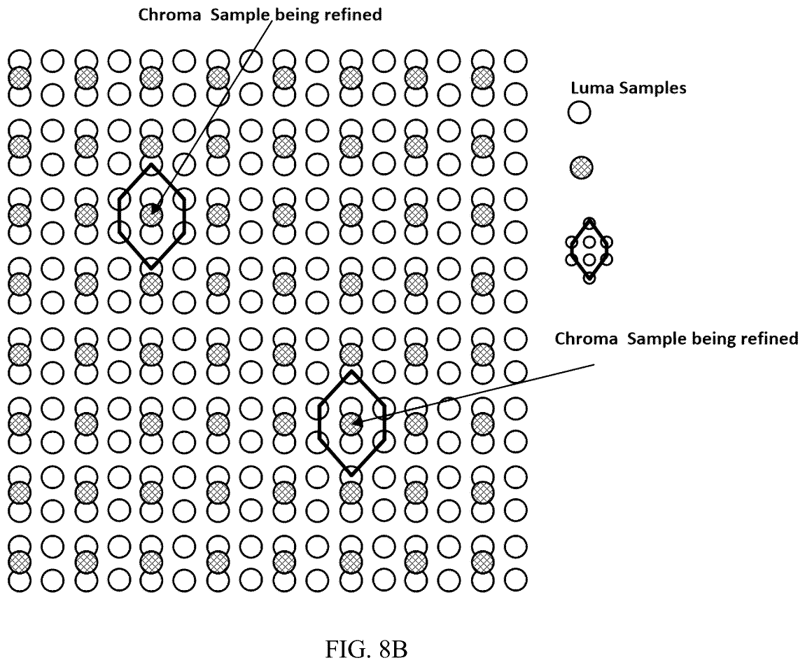

FIGS. 8A and 8B illustrate an example of a placement of cross-component ALF (CC-ALF) with respect to other loop filters, and a diamond shaped filter, respectively.

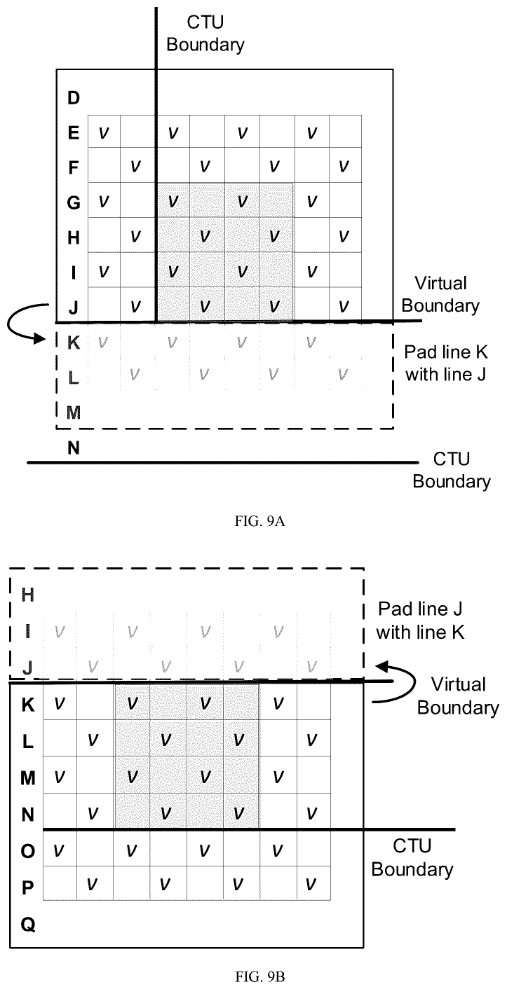

FIGS. 9A and 9B illustrate examples of modified block classifications at virtual boundaries.

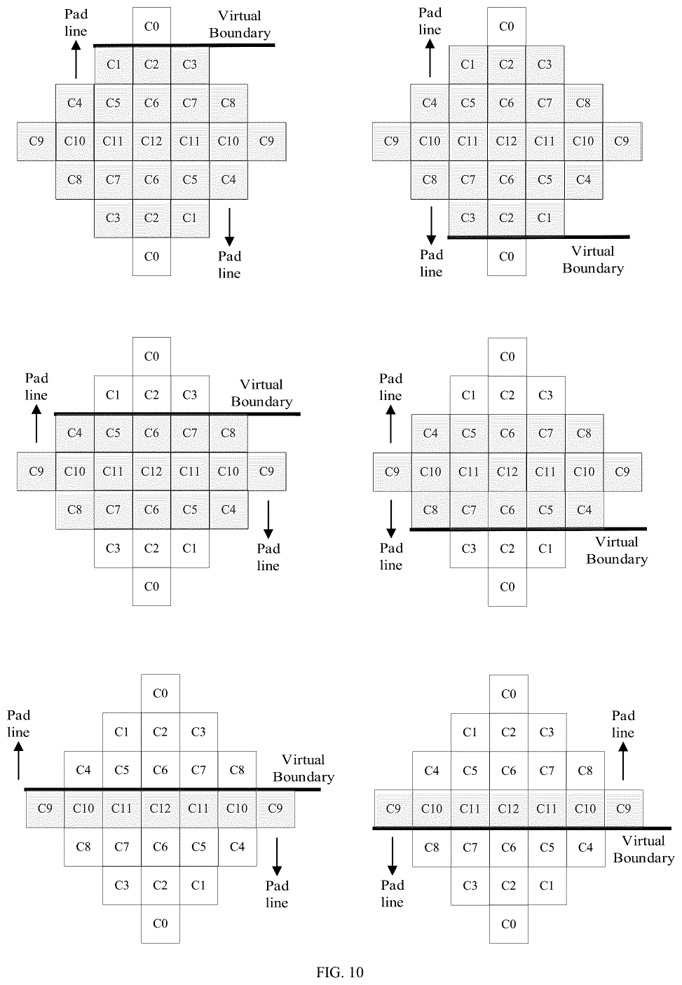

FIG. 10 illustrates an example modified ALF filtering for Luma component at virtual boundaries.

FIG. 11 illustrates an example sample position of pi,k and qi,k.

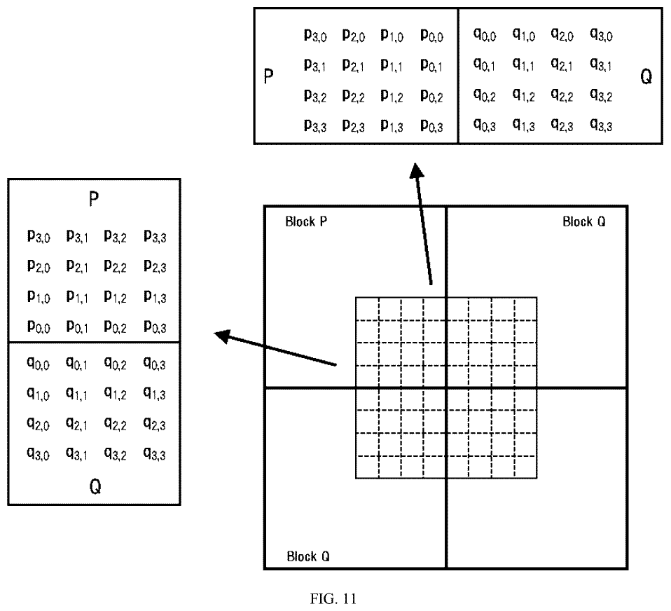

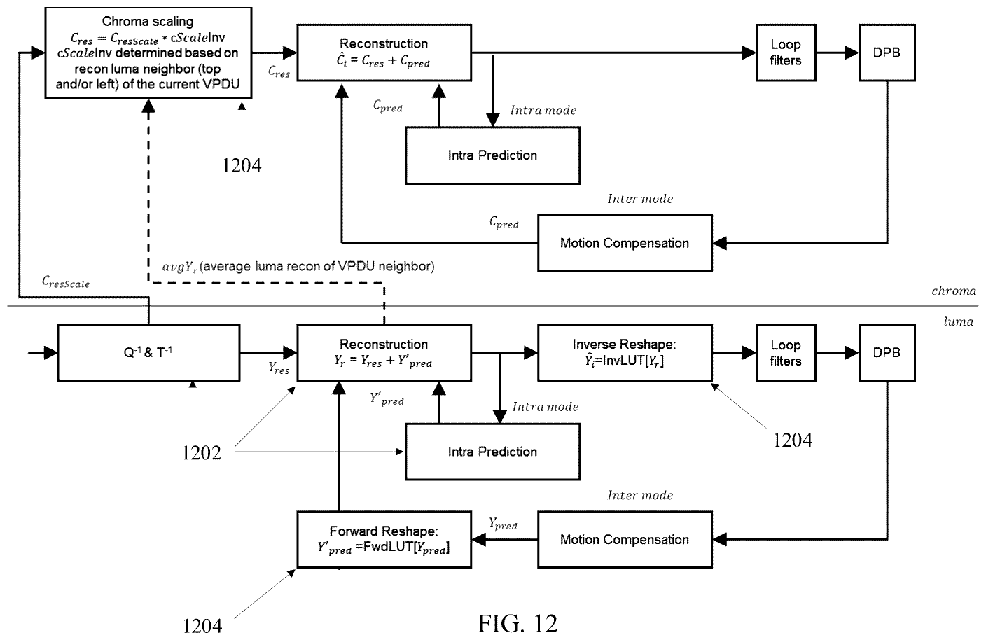

FIG. 12 illustrates an example luma mapping with chroma scaling architecture.

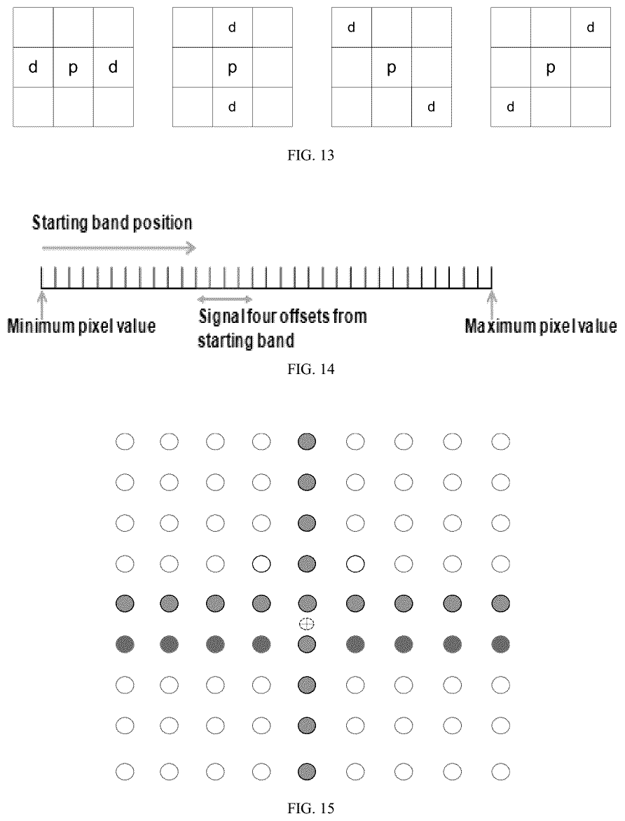

FIG. 13 illustrates an example four one-dimensional (1-D) 3-pixel patterns for the pixel classification in edge offset (EO).

FIG. 14 illustrates an example of four bands are grouped together and represented by its starting band position.

FIG. 15 illustrates an example 25-tap long filter.

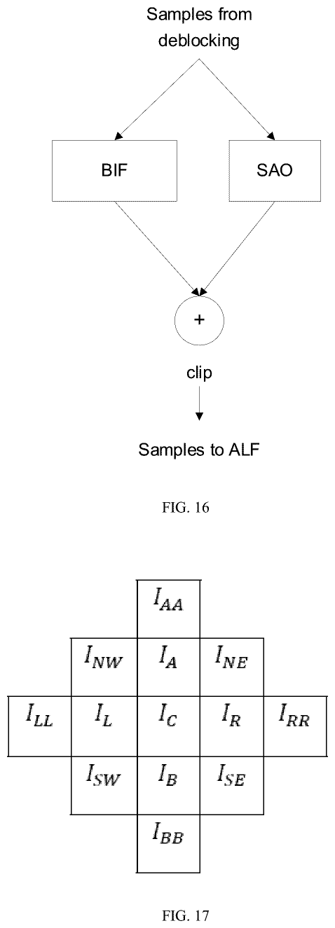

FIG. 16 illustrates an example of both bilateral filter (BIF) and sample adaptive offset (SAO) use samples from the deblocking stage as input. Both create an offset, and these are added to the input sample and clipped.

FIG. 17 illustrates an example naming convention for samples surrounding the center sample, I_C.

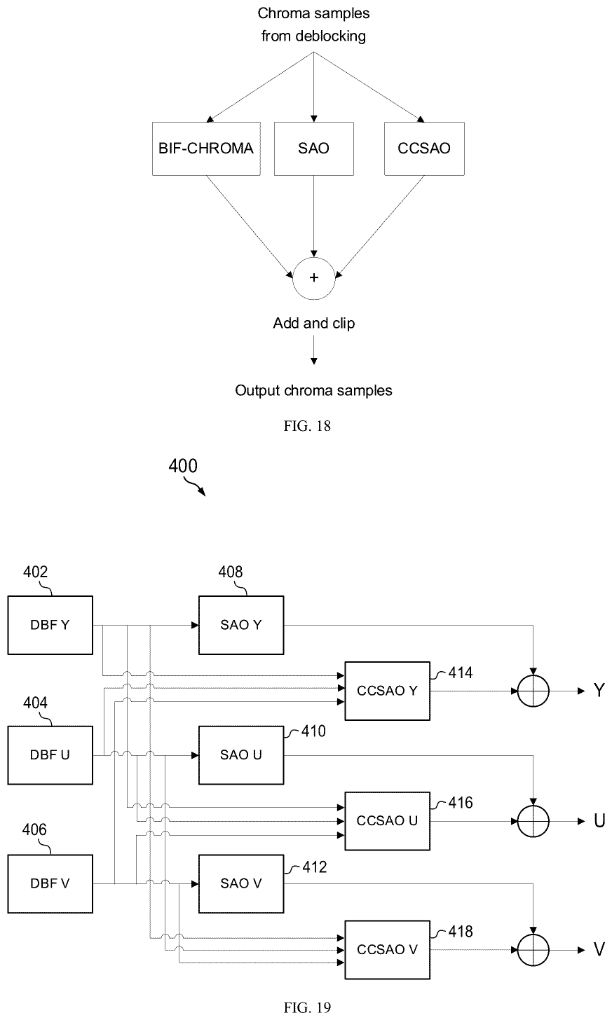

FIG. 18 illustrates an example filtering stage of BIF-Chroma.

FIG. 19 illustrates an example modified SAO process when the proposed CCSAO is applied.

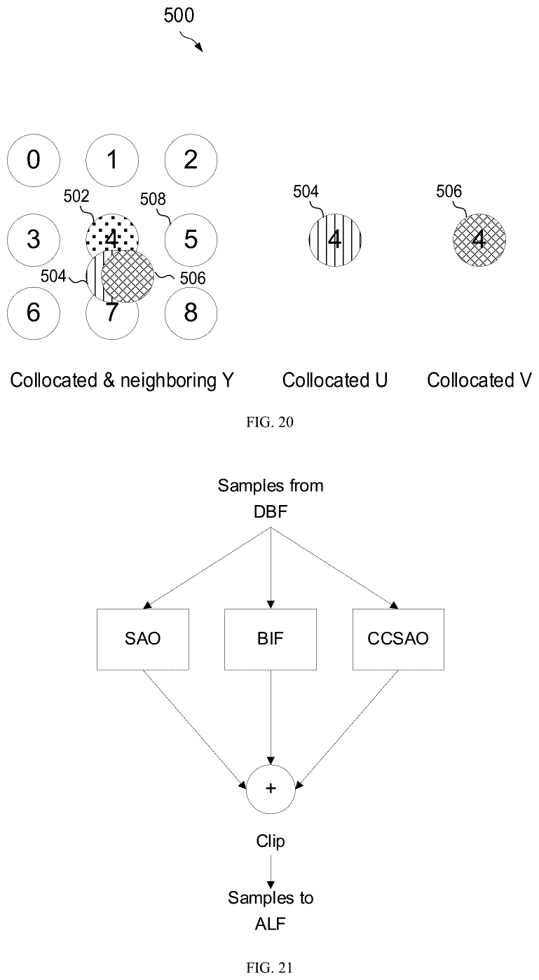

FIG. 20 illustrates an example of the candidate positions used for the CCSAO classifier.

FIG. 21 illustrates an example joint clipping after adding SAO/BIF/CCSAO offsets to the input sample.

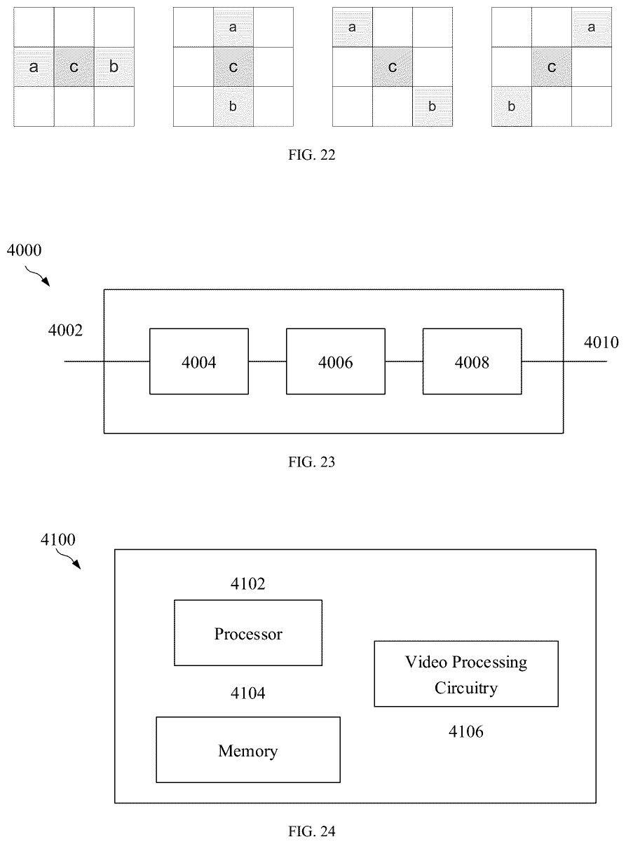

FIG. 22 illustrates an example four 1-D directional patterns for CCSAO EO sample classification: horizontal (EO class=0), vertical (EO class=1), 135° diagonal and 45° diagonal.

FIG. 23 is a block diagram showing an example video processing system.

FIG. 24 is a block diagram of an example video processing apparatus.

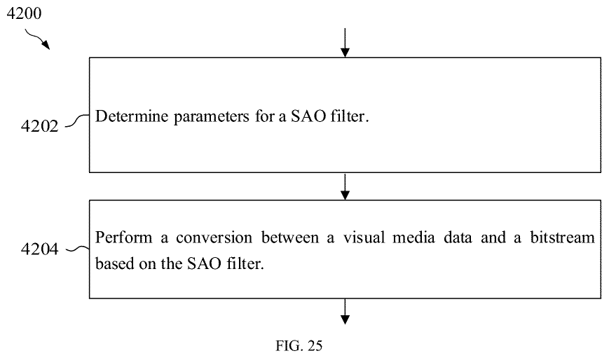

FIG. 25 is a flowchart for an example method of video processing.

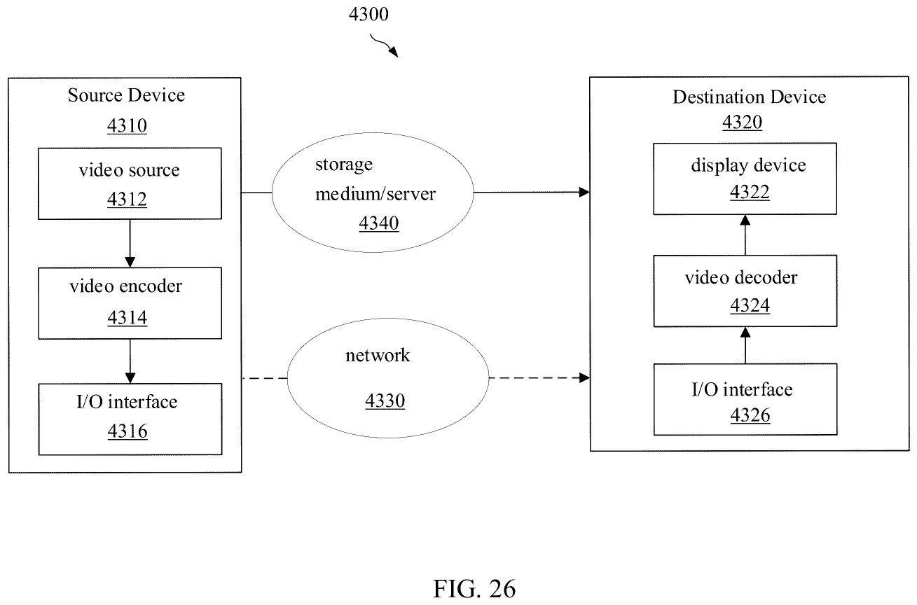

FIG. 26 is a block diagram that illustrates an example video coding system.

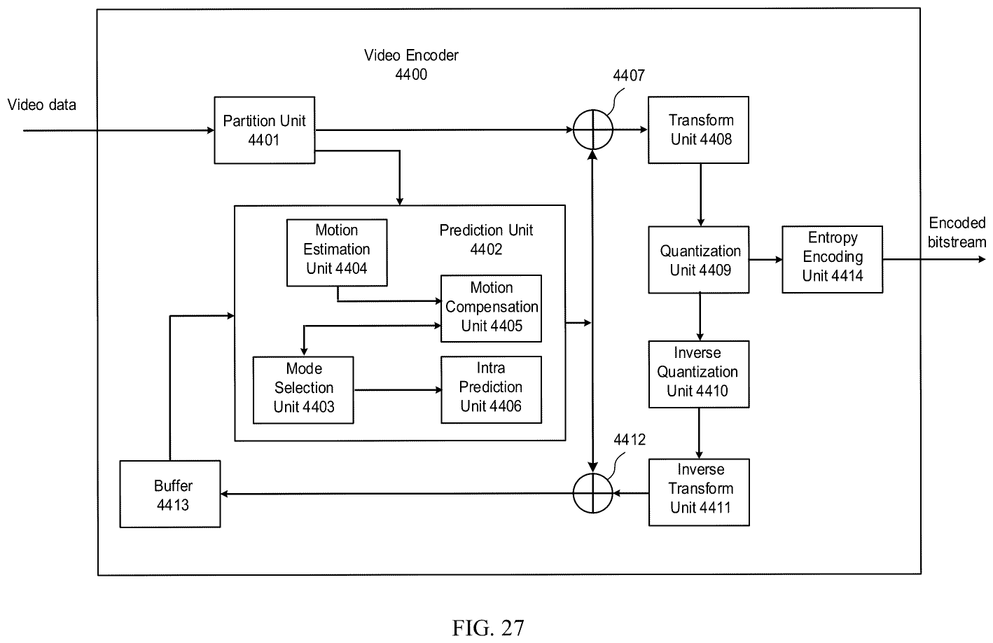

FIG. 27 is a block diagram that illustrates an example encoder.

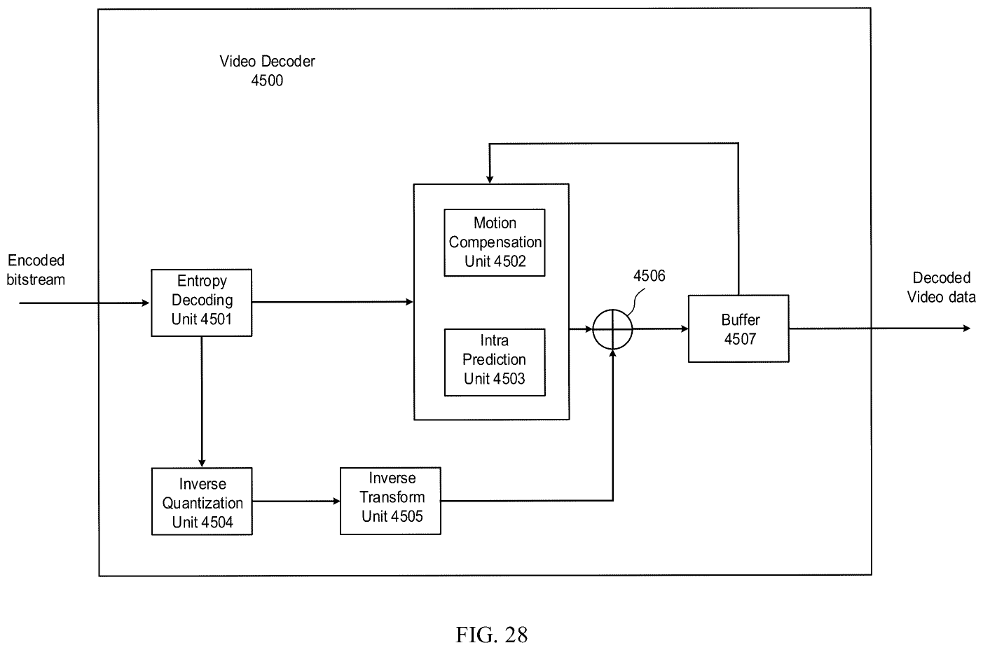

FIG. 28 is a block diagram that illustrates an example decoder.

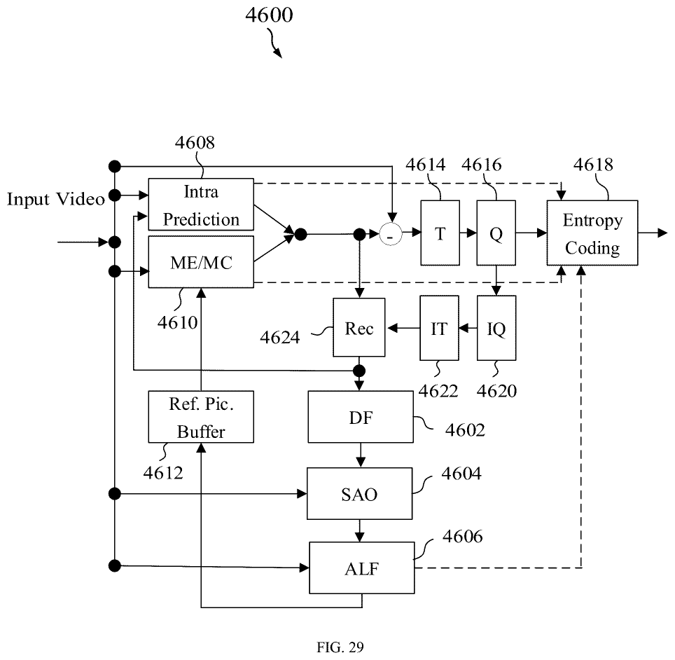

FIG. 29 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, the embodiments described herein are applicable to other video codec protocols and designs.

### 1. INITIAL DISCUSSION

This disclosure is related to video coding technologies. Specifically, it is related to samples adaptive offset (SAO) and cross-component SAO (CCSAO), how to and/or whether to signal/derive the parameters of SAO and CCSAO, and other coding tools in image/video coding. The concepts may be applied to video codecs, such as High Efficiency Video Coding (HEVC), Versatile Video Coding (VVC), or other video coding technologies.

### 2. VIDEO CODING STANDARDS

Video coding standards have evolved primarily through the development of the ITU-T and International Organization for Standardization (ISO)/International Electrotechnical Commission (IEC) standards. The International Telecommunication Union-Telecommunication Standardization Sector (ITU-T) produced H.261 and H.263, ISO/IEC produced Moving Picture Experts Group (MPEG)-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by Video Coding Experts Group (VCEG) and MPEG jointly. Many methods have been adopted by JVET and put into the reference software named Joint Exploration Model (JEM). The Joint Video Expert Team (JVET) between video coding experts group (VCEG) (Q6/16) and ISO/IEC JTC1 SC29/WG11 of the MPEG was created to work on the VVC standard targeting a 50% bitrate reduction compared to HEVC.

### 2.1 Color Space and Chroma Subsampling

Color space, also known as the color model (or color system), is a mathematical model which describes the range of colors as tuples of numbers, for example as 3 or 4 values or color components (e.g., RGB). Generally speaking, a color space is an elaboration of the coordinate system and sub-space. For video compression, the most frequently used color spaces are luma, blue difference chroma, and red difference chroma (YCbCr) and red, green, blue (RGB).

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

### 2.1.1 4:4:4

In 4:4:4, each of the three Y′CbCr components have the same sample rate. Thus, there is no chroma subsampling. This scheme is sometimes used in high-end film scanners and cinematic post production.

### 2.1.2 4:2:2

FIG. 1 illustrates an example of nominal vertical and horizontal locations of 4:2:2 luma and chroma samples in a picture. In 4:2:2, the two chroma components are sampled at half the sample rate of luma. The horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 1.

### 2.1.3 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.

In MPEG-2, Cb and Cr are cosited horizontally. Cb and Cr are sited between pixels in the vertical direction (sited interstitially). In JPEG/JFIF, H.261, and MPEG-1, Cb and Cr are sited interstitially, halfway between alternate luma samples. In 4:2:0 DV, Cb and Cr are co-sited in the horizontal direction. In the vertical direction, they are co-sited on alternating lines.

TABLE 1
SubWidthC and SubHeightC values derived from chroma_format_idc
and separate_colour_plane_flag

| chroma_ | separate_colour_ | Chroma | | |
|---|---|---|---|---|
| format_idc | plane_flag | format | SubWidthC | SubHeightC |
| 0 | 0 | Monochrome | 1 | 1 |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 2.2 Example Coding Flow of a Video Codec

FIG. 2 illustrates an example encoder block diagram. FIG. 2 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages.

### 2.3 Intra Mode Coding with 67 Intra Prediction Modes

FIG. 3 illustrates an example of 67 intra prediction modes. To capture the arbitrary edge directions presented in natural video, the number of directional intra modes is extended from 33, as used in HEVC, to 65. The additional directional modes are depicted in FIG. 3, and the planar and DC modes remain the same. These denser directional intra prediction modes apply for all block sizes and for both luma and chroma intra predictions.

In the HEVC, every intra-coded block has a square shape and the length of each of the block's sides is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.3.1 Wide Angle Intra Prediction

Although 67 modes are defined in the VVC, the exact prediction direction for a given intra prediction mode index is further dependent on the block shape. In some examples, angular intra prediction directions are defined from 45 degrees to −135 degrees in clockwise direction. In VVC, several conventional angular intra prediction modes are adaptively replaced with wide-angle intra prediction modes for non-square blocks. The replaced modes are signaled using the original mode indexes, which are remapped to the indexes of wide angular modes after parsing. The total number of intra prediction modes is unchanged, i.e., 67, and the intra mode coding method is unchanged.

FIG. 4 illustrates an example of reference samples for wide-angular intra prediction. To support these prediction directions, the top reference with length 2 W+1, and the left reference with length 2H+1, are defined as shown in FIG. 4. The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, |
| | 65, 66 |
| W/H == 1/16 | Modes 53, 54, 55, 56, 57, 58, 59, 60, 61, 62, |
| | 63, 64, 65, 66 |

FIG. 5 illustrates an example problem of discontinuity in case of directions beyond 45°. As shown in FIG. 5, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset, there are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed for smoothing is reduced. Besides, this aligns the design of non-fractional modes in the general prediction mode set and wide-angle modes.

In VVC, 4:2:2 and 4:4:4 chroma formats are supported as well as 4:2:0. Chroma derived mode (DM) derivation table for 4:2:2 chroma format was ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2 chroma format is updated by replacing some values of the entries of the mapping table to convert prediction angle more precisely for chroma blocks.

### 2.4 Inter Prediction

For each inter-predicted coding unit (CU), motion parameters include motion vectors, reference picture indices, reference picture list usage index, and additional information used for the new coding feature of VVC to be used for inter-predicted sample generation. The motion parameters can be signaled in an explicit or implicit manner. When a CU is coded with skip mode, the CU is associated with one prediction unit (PU) and has no significant residual coefficients, no coded motion vector delta, and/or reference picture index. A merge mode is specified whereby the motion parameters for the current CU are obtained from neighboring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list, reference picture list usage flag, and other useful information are signaled explicitly per each CU.

### 2.5 Intra Block Copy (IBC)

Intra block copy (IBC) is a tool adopted in HEVC extensions on screen content coding (SCC). This significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with adaptive motion vector resolution (AMVR), the IBC mode can switch between 1-pel and 4-pel motion vector precisions. An IBC-coded CU is treated as the third prediction mode other than intra or inter prediction modes. The IBC mode is applicable to the CUs with both width and height less than or equal to 64 luma samples.

At the encoder side, hash-based motion estimation is performed for IBC. The encoder performs rate-distortion (RD) check for blocks with either width or height no larger than 16 luma samples. For non-merge mode, the block vector search is performed using hash-based search first. If hash search does not return valid candidate, block matching based local search will be performed.

In the hash-based search, hash key matching (32-bit cyclic redundancy check (CRC)) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current coding tree units (CTUs). At CU level, IBC mode is signalled with a flag and it can be signaled as IBC adaptive motion vector prediction (AMVP) mode or IBC skip/merge mode as follows. IBC skip/merge mode: a merge candidate index is used to indicate which of the block vectors in the list from neighboring candidate IBC coded blocks is used to predict the current block. The merge list consists of spatial, history-based motion vector prediction (HMVP), and pairwise candidates. IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.6 Adaptive Loop Filter

In VVC, an ALF with block-based filter adaption is applied. For the luma component, one among 25 filters is selected for each 4×4 block, based on the direction and activity of local gradients.

### 2.6.1 Filter Shape

In the JEM, up to three diamond filter shapes (as shown in FIG. 6) can be selected for the luma component. An index is signalled at the picture level to indicate the filter shape used for the luma component. Each square represents a sample, and Ci (i being 0˜6 (left), 0˜12 (middle), 0˜20 (right)) denotes the coefficient to be applied to the sample. In some examples, for chroma components in a picture, the 5×5 diamond shape is always used. FIG. 6 illustrates an example of ALF filter shapes, such as chroma: 5×5 diamond and luma: 7×7 diamond. FIG. 6 includes example ALF filter shapes including a chroma: 5×5 diamond and a luma: 7×7 diamond. Two diamond filter shapes (as shown in FIG. 6) are used. The 7×7 diamond shape is applied for luma component and the 5×5 diamond shape is applied for chroma components.

### 2.6.2 Block Classification

For luma component, each 4×4 block is categorized into one out of 25 classes. The classification index C is derived based on its directionality D and a quantized value of activity Â, as follows:

$$C = 5 D + \hat{A} \qquad ( 2 - 1 )$$

To calculate D and Â, gradients of the horizontal, vertical and two diagonal directions are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert \qquad ( 2 - 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert \qquad ( 2 - 3 )$$

$${g}_{d 1} = {\sum }_{k = i - 2}^{i + 3} {\sum }_{l = j - 3}^{j + 3} D {1}_{k , l} , \\ D {1}_{k , l} = \vert 2 R ( k , l ) - R ( k - 1 , l - 1 ) - R ( k + 1 , l + 1 ) \vert \qquad ( 2 - 4 )$$

$${g}_{d 2} = {\sum }_{k = i - 2}^{i + 3} {\sum }_{j = j - 2}^{j + 3} D {2}_{k , l} , \\ D {2}_{k , l} = \vert 2 R ( k , l ) - R ( k - 1 , l + 1 ) - R ( k + 1 , l - 1 ) \vert \qquad ( 2 - 5 )$$

Where indices i and j refer to the coordinates of the upper left sample within the 4×4 block and R(i,j) indicates a reconstructed sample at coordinate (i,j).

FIG. 7 illustrates an example of a subsampled Laplacian calculation. To reduce the complexity of block classification, the subsampled 1-D Laplacian calculation is applied. As shown in FIG. 7, the same subsampled positions are used for gradient calculation of all directions. This includes Subsampled positions for vertical gradient, horizontal gradient, first diagonal gradient, and second diagonal gradient are indicated in FIG. 7 as v, h, 01, and 02, respectively.

Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) \qquad ( 2 - 6 )$$

The maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) \qquad ( 2 - 7 )$$

To derive the value of the directionality D, these values are compared against each other and with two thresholds t₁ and t₂:
Step 1. If both g_{h,v}^{max}≤t₁·g_{h,v}^{min} and g_{d0,d1}^{max}≤t₁·g_{d0,d1}^{min} are true, D is set to 0.
Step 2. If g_{h,v}^{max}/g_{h,v}^{min}>g_{d0,d1}^{max}/g_{d0,d1}^{min}, continue from Step 3; otherwise continue from Step 4.
Step 3. If g_{h,v}^{max}>t₂·g_{h,v}^{min}, D is set to 2; otherwise D is set to 1.
Step 4. If g_{d0,d1}^{max}>t₂·g_{d0,d1}^{min}, D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) \qquad ( 2 - 8 )$$

A is further quantized to the range of 0 to 4, inclusively, and the quantized value is denoted as Â. For chroma components in a picture, no classification method is applied.

### 2.6.3 Geometric Transformations of Filter Coefficients and Clipping Values

Before filtering each 4×4 luma block, geometric transformations such as rotation or diagonal and vertical flipping are applied to the filter coefficients f(k,l) and to the corresponding filter clipping values c(k,l) depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , {c}_{D} ( k , l ) = c ( l , k ) , \qquad ( 2 - 9 )$$

$$Vertical flip : {f}_{V} ( k , l ) = f ( k , K - l - 1 ) , {c}_{V} ( k , l ) = c ( k , K - l - 1 ) \qquad ( 2 - 10 )$$

$$Rotation : {f}_{R} ( k , l ) = f ( K - l - 1 , k ) , {c}_{R} ( k , l ) = c ( K - l - 1 , k ) \qquad ( 2 - 11 )$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k,l) and to the clipping values c(k,l) depending on gradient values calculated for that block. The relationship between the transformation and the four gradients of the four directions are summarized in the following table.

TABLE 3
Mapping of the gradient calculated for one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.6.4 Filtering Process

At decoder side, when ALF is enabled for a CTB, each sample R(i,j) within the CU is filtered, resulting in sample value R′(i,j) as shown below:

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 ) \qquad ( 2 - 12 )$$

where f(k,l) denotes the decoded filter coefficients, K(x,y) is the clipping function and c(k,l) denotes the decoded clipping parameters. The variables k and l vary between

$$- \frac{L}{2} and \frac{L}{2}$$

where L denotes the filter length. The clipping function K(x,y)=min(y,max(−y,x)) which corresponds to the function Clip3(−y,y,x). The clipping operation introduces non-linearity to make ALF more efficient by reducing the impact of neighbor sample values that are too different with the current sample value.

### 2.6.5 Cross Component Adaptive Loop Filter

CC-ALF uses luma sample values to refine each chroma component by applying an adaptive, linear filter to the luma channel and then using the output of this filtering operation for chroma refinement. FIG. 8A illustrates an example of a placement of CC-ALF with respect to other loop filters and a diamond shaped filter. FIG. 8A provides a system level diagram of the CC-ALF process with respect to the SAO, luma ALF and chroma ALF processes. Filtering in CC-ALF is accomplished by applying a linear, diamond shaped filter to the luma channel, as shown in FIG. 8B. One filter is used for each chroma channel, and the operation is expressed as

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} ) \qquad ( 2 - 13 )$$

where (x,y) is chroma component i location being refined (x_{Y},Y_{Y}) is the luma location based on (x,y), Sᵢ is filter support area in luma component, cᵢ(x₀,y₀) represents the filter coefficients. As shown, the luma filter support is the region collocated with the current chroma sample after accounting for the spatial scaling factor between the luma and chroma planes.

In the VVC reference software, CC-ALF filter coefficients are computed by minimizing the mean square error of each chroma channels with respect to the original chroma content. To achieve this, the VVC test model (VTM) algorithm uses a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

Additional characteristics of CC-ALF include the following. The design uses a 3×4 diamond shape with 8 taps. Seven filter coefficients are transmitted in the adaptation parameter set (APS). Each of the transmitted coefficients has a 6-bit dynamic range and is restricted to power-of-2 values. The eighth filter coefficient is derived at the decoder such that the sum of the filter coefficients is equal to 0. An APS may be referenced in the slice header. CC-ALF filter selection is controlled at CTU-level for each chroma component. Boundary padding for the horizontal virtual boundaries uses the same memory access pattern as luma ALF.

As an additional feature, the reference encoder can be configured to enable some basic subjective tuning through the configuration file. When enabled, the VTM attenuates the application of CC-ALF in regions that are coded with high quantization parameter (QP) and are either near mid-grey or contain a large amount of luma high frequencies. Algorithmically, this is accomplished by disabling the application of CC-ALF in CTUs where any of the following conditions are true: the slice QP value minus 1 is less than or equal to the base QP value; the number of chroma samples for which the local contrast is greater than (1<< (bitDepth−2))−1 exceeds the CTU height, where the local contrast is the difference between the maximum and minimum luma sample values within the filter support region; or more than a quarter of chroma samples are in the range between (1<< (bitDepth−1))−16 and (1<< (bitDepth−1))+16.

The motivation for this functionality is to provide some assurance that CC-ALF does not amplify artifacts introduced earlier in the decoding path, such as due to the fact that the VTM does not explicitly optimize for chroma subjective quality. Alternative encoder implementations may either not use this functionality or incorporate alternative strategies suitable for their encoding characteristics.

### 2.6.6 Filter Parameters Signaling

ALF filter parameters are signalled in the APS. In one APS, up to 25 sets of luma filter coefficients and clipping value indexes, and up to eight sets of chroma filter coefficients and clipping value indexes could be signalled. To reduce bits overhead, filter coefficients of different classification for luma component can be merged. In slice header, the indices of the APSs used for the current slice are signaled. Clipping value indexes, which are decoded from the APS, allow determining clipping values using a table of clipping values for both luma and Chroma components. These clipping values are dependent of the internal bitdepth. More precisely, the clipping values are obtained by the following formula:

$$AlfClip = \{ round ( {2}^{B - α * n} ) for n ∈ [ 0 … N - 1 ] \} \qquad ( 2 - 14 )$$

with B equal to the internal bitdepth, α is a pre-defined constant value equal to 2.35, and N equal to 4 which is the number of allowed clipping values in VVC. The AlfClip is then rounded to the nearest value with the format of power of 2.

In slice header, up to 7 APS indices can be signaled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signaled for a luma CTB to indicate which filter set is applied. The 16 fixed filter sets are pre-defined and hard-coded in both the encoder and the decoder.

For chroma components, an APS index is signaled in slice header to indicate the chroma filter sets being used for the current slice. At CTB level, a filter index is signaled for each chroma CTB if there is more than one chroma filter set in the APS. The filter coefficients are quantized with norm equal to 128. In order to restrict the multiplication complexity, a bitstream conformance is applied so that the coefficient value of the non-central position shall be in the range of −27 to 27−1, inclusive. The central position coefficient is not signalled in the bitstream and is considered as equal to 128.

### 2.6.7 Virtual Boundary Filtering Process for Line Buffer Reduction

FIGS. 9A and 9B illustrate an example modified block classification at virtual boundaries. In VVC, to reduce the line buffer requirement of ALF, modified block classification and filtering are employed for the samples near horizontal CTU boundaries. For this purpose, a virtual boundary is defined as a line by shifting the horizontal CTU boundary with N samples as shown in FIGS. 9A and 9B, with N equal to 4 for the Luma component and 2 for the Chroma component.

Modified block classification is applied for the Luma component as depicted in FIGS. 9A and 9B. For the 1D Laplacian gradient calculation of the 4×4 block above the virtual boundary (as in FIG. 9A), only the samples above the virtual boundary are used. Similarly, for the 1D Laplacian gradient calculation of the 4×4 block below the virtual boundary (as in FIG. 9B), only the samples below the virtual boundary are used. The quantization of activity value A is accordingly scaled by taking into account the reduced number of samples used in 1D Laplacian gradient calculation.

FIG. 10 illustrates an example modified ALF filtering for Luma component at virtual boundaries. For filtering processing, symmetric padding operation at the virtual boundaries are used for both Luma and Chroma components. As shown in FIG. 10, when the sample being filtered is located below the virtual boundary, the neighboring samples that are located above the virtual boundary are padded. Meanwhile, the corresponding samples at the other sides are also padded, symmetrically.

Different to the symmetric padding method used at horizontal CTU boundaries, simple padding process is applied for slice, tile and subpicture boundaries when filter across the boundaries is disabled. The simple padding process is also applied at picture boundary. The padded samples are used for both classification and filtering process. To compensate for the extreme padding when filtering samples just above or below the virtual boundary the filter strength is reduced for those cases for both Luma and Chroma by increasing the right shift in equation 2-12 by 3.

### 2.7 Deblocking Filter

Deblocking filtering is an example in-loop filter in video codec. In VVC, the deblocking filtering process is applied on CU boundaries, transform subblock boundaries, and prediction subblock boundaries. The prediction subblock boundaries include the prediction unit boundaries introduced by the Subblock-based Temporal Motion Vector prediction (SbTMVP) and affine modes. The transform subblock boundaries include the transform unit boundaries introduced by Subblock transform (SBT) and Intra Sub-Partitions (ISP) modes and transforms due to implicit split of large CUs. The processing order of the deblocking filter is defined as horizontal filtering for vertical edges for the entire picture first, followed by vertical filtering for horizontal edges. This specific order enables either multiple horizontal filtering or vertical filtering processes to be applied in parallel threads. Filtering processes can also be implemented on a CTB-by-CTB basis with only a small processing latency.

Compared to HEVC deblocking, the following modifications are introduced. The filter strength of the deblocking filter is dependent of the averaged luma level of the reconstructed samples. Further changes include a Deblocking tC table extension and adaptation to 10-bit video, a 4×4 grid deblocking for luma, a stronger deblocking filter for luma, a stronger deblocking filter for chroma, a deblocking filter for subblock boundary, and deblocking decision adapted to smaller difference in motion.

### 2.7.1 Luma Adaptive Deblocking Filter Strength

As done in HEVC, the filter strength of the deblocking filter in VVC is controlled by the variables β and tC which are derived from the averaged quantization parameters qPL of the two adjacent coding blocks. In VVC, luma-adaptive deblocking can further adjust the filtering strength of deblocking filter based on the averaged luma level of the reconstructed samples. This additional refinement is used to compensate the nonlinear transfer function such as Electro-Optical Transfer Function (EOTF) in the linear light domain.

FIG. 11 illustrates an example sample position of pi,k and qi,k. In this method, deblocking filter controls the strength of the deblocking filter by adding offset to qPL according to the luma level of the reconstructed samples. The reconstructed luma level LL is derived as follows:

$$L L = ( ( {p}_{0 , 0} + {p}_{0 , 3} + {q}_{0 , 0} + {q}_{0 , 3} ) ≫ 2 ) / ( 1 ≪ bitDepth ) \qquad ( 2 - 15 )$$

where, the sample values pi,k and qi,k with i=0 . . . 3 and k=0 and 3 are derived as shown in FIG. 11.

The variable qPL is derived as follows:

$$q P L = ( ( QpQ + QpP + 1 ) ≫ 1 ) + qpOffset \qquad ( 2 - 16 )$$

where QpQ and QpP denote the quantization parameters of the coding units containing the sample q0,0 and p0,0, respectively. The offset qpOffset is dependent on transfer function and the reconstructed luma level LL. The mapping function of qpOffset and the luma level are signalled in the SPS and should be derived according to the transfer characteristics of the contents since the transfer functions vary among video formats.

### 2.7.2 Deblocking tC Table Extension and Adaptation to 10-Bit Video

In VVC, the maximum QP was changed from 51 to 63, and it is desired to reflect corresponding changes to a deblocking table, which derives values of deblocking parameters tC based on the block QP. The table was also adapted to 10-bit video instead of 8-bit video as was the case for HEVC. The following is updated tC table to accommodate the extension of the QP range and 10-bit video.

tC=[0, 0, 0, 0, 0, 0, 0, 0, 0, 0, 0, 0, 0, 0, 0, 0, 0, 0, 3,4,4,4,4,5,5,5,5,7,7,8,9,10,10,11,13,14,15,17,19,21,24,25,29,33,36,41,45,51,57,64,71,80,89,100,112,125,141,15 7,177,198,222,250,280,314,352,395]

### 2.7.3 4×4 Deblocking Grid for Luma

HEVC uses an 8×8 deblocking grid for both luma and chroma. In VVC, deblocking on a 4×4 grid for luma boundaries was introduced to handle blocking artifacts from rectangular transform shapes. Parallel-friendly luma deblocking on a 4×4 grid is achieved by restricting the number of samples to be deblocked to 1 sample on each side of a vertical luma boundary where one side has a width of 4 or less or to 1 sample on each side of a horizontal luma boundary where one side has a height of 4 or less.

### 2.7.4 Stronger Deblocking Filter for Luma

A bilinear filter (e.g., a stronger deblocking filter) is used when samples at either one side of a boundary belong to a large block. A sample belonging to a large block is defined as when the width is greater than or equal to 32 for a vertical edge, and when height is greater than or equal to 32 for a horizontal edge. Block boundary samples pi for i=0 to Sp−1 and qi for j=0 to Sq−1 are then replaced by linear interpolation as follows:

$${p}_{i}^{′} = ( {f}_{i} * {Middle}_{s , t} + ( 64 - {f}_{i} ) * {P}_{s} + 32 ) ≫ 6 ) , \\ clipped to {p}_{i} \pm {tcPD}_{i} \qquad ( 2 - 17 )$$

$${q}_{j}^{′} = ( {g}_{j} * {Middle}_{s , t} + ( 64 - {g}_{j} ) * {Q}_{s} + 32 ) ≫ 6 ) , \\ clipped to {q}_{j} \pm {tcPD}_{j} \qquad ( 2 - 18 )$$

where tcPDᵢ and tcPDⱼ term is a position dependent clipping described above and gⱼ, fᵢ, Middle_{s,t}, Pₛ and Qₛ are given below:

TABLE 4
Derivation of stronger deblocking parameters for luma

| | |
|---|---|
| Sp, Sq | fᵢ = 59 − i * 9, can also be described as f = {59, 50, 41, 32, 23, 14, 5} |
| 7, 7 | gⱼ = 59 − j * 9, can also be described as g = {59, 50, 41, 32, 23, 14, 5} |
| (p side: 7, | Middle_{7,7} = (2 * (pₒ + qₒ) + p₁ + q₁ + p₂ + q₂ + p₃ + q₃ + p₄ + q₄ + p₅ + q₅ + p₆ + q₆ + 8) >> 4 |
| q side: 7) | P₇ = (p₆ + p₇ + 1) >> 1, Q₇ = (q₆ + q₇ + 1) >> 1 |
| 7, 3 | fᵢ = 59 − i * 9, can also be described as f = {59, 50, 41, 32, 23, 14, 5} |
| (p side: 7 | gⱼ = 53 − j * 21, can also be described as g = {53, 32, 11} |
| q side: 3) | Middle_{7,3} = (2 * (pₒ + qₒ) + q₀+ 2 * (q₁ + q₂) + p₁ + q₁ + p₂ + p₃ + p₄ + p₅ + p₆ + 8) >> 4 |
| | P₇ = (p₆ + p₇ + 1) >> 1, Q₃ = (q₂ + q₃ + 1) >> 1 |
| 3, 7 | gⱼ = 59 − j * 9, can also be described as g = {59, 50, 41, 32, 23, 14, 5} |
| (p side: 3 | fᵢ = 53 − i * 21, can also be described as f = {53, 32, 11} |
| q side: 7) | Middle_{3.7} = (2 * (qₒ + pₒ) + p₀ + 2 * (p₁ + p₂) + q₁ + p₁ + q₂ + q₃ + q₄ + q₅ + q₆ + 8) >> 4 |
| | Q₇ = (q₆ + q₇ + 1) >> 1, P₃ = (p₂ + p₃ + 1) >> 1 |
| 7, 5 | gⱼ = 58 − j * 13, can also be described as g = {58, 45, 32, 19, 6} |
| (p side: 7 | fᵢ = 59 − i * 9, can also be described as f = {59, 50, 41, 32, 23, 14, 5} |
| q side: 5) | Middle7,5 = (2 * (pₒ + qₒ + p₁ + q₁) + q₂ + p₂ + q₃ + p₃ + q₄ + p₄ + q₅ + p₅ + 8) >> 4 |
| | Q₅ = (q₄ + q₅ + 1) >> 1, P₇ = (p₆ + p₇ + 1) >> 1 |
| 5, 7 | gⱼ = 59 − j * 9, can also be described as g = {59, 50, 41, 32, 23, 14, 5} |
| (p side: 5 | fᵢ = 58 − i * 13, can also be described as f = {58, 45, 32, 19, 6} |
| q side: 7) | Middle5,7 = (2 * (qₒ + pₒ + p₁ + q₁) + q₂ + p₂ + q₃ + p₃ + q₄ + p₄ + q₅ + p₅ + 8) >> 4 |
| | Q₇ = (q₆ + q₇ + 1) >> 1, P₅ = (p₄ + p₅ + 1) >> 1 |
| 5, 5 | gⱼ = 58 − j * 13, can also be described as g = {58, 45, 32, 19, 6} |
| (p side: 5 | fᵢ = 58 − i * 13, can also be described as f = {58, 45, 32, 19, 6} |
| q side: 5) | Middle5,5 = (2 * (qₒ + pₒ + p₁ + q₁ + q₂ + p₂) + q₃ + p₃ + q₄ + p₄ + 8) >> 4 |
| | Q₅ = (q₄ + q₅ + 1) >> 1, P₅ = (p₄ + p₅ + 1) >> 1 |
| 5, 3 | gⱼ = 53 − j * 21, can also be described as g = {53, 32, 11} |
| (p side: 5 | fᵢ = 58 − i * 13, can also be described as f = {58, 45, 32, 19, 6} |
| q side: 3) | Middle5,3 = (qₒ + pₒ + p₁ + q₁ + q₂ + p₂ + q₃ + p₃ + 4) >> 3 |
| | Q₃ = (q₂ + q₃ + 1) >> 1, P₅ = (p₄ + p₅ + 1) >> 1 |
| 3, 5 | gⱼ = 58 − j * 13, can also be described as g = {58, 45, 32, 19, 6} |
| (p side: 3 | fᵢ = 53 − i * 21, can also be described as f = {53, 32, 11} |
| q side: 5) | Middle3,5 = (qₒ + pₒ + p₁ + q₁ + q₂ + p₂ + q₃ + p₃ + 4) >> 3 |
| | Q₅ = (q₄ + q₅ + 1) >> 1, P₃ = (p₂ + p₃ + 1) >> 1 |

Above mentioned stronger luma filters are used only if all of the Condition1, Condition2 and Condition 3 are TRUE. The condition 1 is the “large block condition”. This condition detects whether the samples at P-side and Q-side belong to large blocks. The condition 2 and condition 3 are determined by:

$$Condition 2 = ( d < β ) ? TRUE : FALSE$$

$$Condition 3 = StrongFilterCondition = ( dpq is less than ( β ≫ 4 ) ,$$

$$sp + sq is less than ( 3 * β ≫ 5 ) , and$$

$$Abs ( p 0 - q 0 ) is less than ( 5 * tC + 1 ) ≫ 1 ) ? TRUE : FALSE$$

where d, dpq, sp and sq are magnitudes of gradient calculations to determine amount of details in comparison to a threshold based on β, a QP dependent coding noise threshold, to avoid removing details by the filtering. Similarly, as HEVC it is also checked that the magnitude of the gradient across the boundary is less than a threshold based on tC, a QP dependent deblocking strength threshold.

### 2.7.5 Strong Deblocking Filter for Chroma

The following strong deblocking filter for chroma is defined:

$$p {2}^{′} = ( 3 * p 3 + 2 * p 2 + p 1 + p 0 + q 0 + 4 ) ≫ 3 \qquad ( 2 - 19 )$$

$$p {1}^{′} = ( 2 * p 3 + p 2 + 2 * p 1 + p 0 + q 0 + q 1 + 4 ) ≫ 3 \qquad ( 2 - 20 )$$

$$p {0}^{′} = ( p 3 + p 2 + p 1 + 2 * p 0 + q 0 + q 1 + q 2 + 4 ) ≫ 3 \qquad ( 2 - 21 )$$

The above chroma filter performs deblocking on an 8×8 chroma sample grid. The chroma strong filters are used on both sides of the block boundary. Here, the chroma filter is selected when both sides of the chroma edge are greater than or equal to 8 (in unit of chroma sample), and the following decision with three conditions are satisfied. The first one is for decision of boundary strength as well as large block. The second and third one are basically the same as for HEVC luma decision, which are on/off decision and strong filter decision, respectively. In the first decision, boundary strength (bS) is modified for chroma filtering as shown in Table 5. The conditions in Table 5 are checked sequentially. If a condition is satisfied, then the remaining conditions with lower priorities are skipped.

TABLE 5
The modified boundary strength

| | | bS | | |
|---|---|---|---|---|
| Priority | Conditions | Y | U | V |
| 6 | At least one of the adjacent blocks is coded | 2 | 2 | 2 |
| | with intra or CIIP mode | | | |
| 5 | At least one of the adjacent blocks has non-zero | 1 | 1 | 1 |
| | transform coefficients | | | |
| 4 | One of the adjacent blocks is coded in IBC | 1 | 1 | 1 |
| | prediction mode and the other is coded in inter | | | |
| | prediction mode | | | |
| 3 | Absolute difference between the motion vectors that | 1 | 0 | 0 |
| | belong to the adjacent blocks is greater than or equal | | | |
| | to one half luma sample | | | |
| 2 | Reference pictures the two adjacent blocks refers to | 1 | 0 | 0 |
| | are different | | | |
| 1 | Otherwise | 0 | 0 | 0 |

Chroma deblocking is performing when bS is equal to 2, or bS is equal to 1 when a large block boundary is detected. The second and third condition is basically the same as HEVC luma strong filter decision.

### 2.7.6 Deblocking Filter for Subblock Boundary

The deblocking filtering process are applied on a 4×4 grid for CU boundaries and transform subblock boundaries and on an 8×8 grid for prediction subblock boundaries. The prediction subblock boundaries include the prediction unit boundaries introduced by SbTMVP and affine modes, and the transform subblock boundaries include the transform unit boundaries introduced by SBT and ISP modes, and transforms due to implicit split of large CUs.

For SBT and ISP subblocks, similar to the logic in transform unit (TU) in HEVC deblocking filter, the deblocking filter is applied on TU boundary when there are non-zero coefficients in either transform subblock across the edge. For SbTMVP and affine prediction subblocks, similar to the logic in prediction unit (PU) in HEVC, the deblocking filter is applied on 8×8 grid with the consideration of the difference between motion vectors and reference pictures of the neighboring prediction subblock.

Transform block boundaries can at most be deblocked with 5 samples on a side of transform boundary which also is part of a coding block where SbTMVP or affine is used to enable parallel friendly deblocking. Internal prediction subblock boundaries 4 samples from a transform block boundary are at most deblocked by 1 sample on each side, internal prediction subblock boundaries 8 samples away from a transform block boundary are at most deblocked by 2 samples on each side of the boundary and other internal prediction subblock boundaries are at most deblocked with 3 samples on each side of the boundary.

### 2.7.7 Deblocking Decision Adapted to Smaller Difference in Motion

HEVC enables deblocking of a prediction unit boundary when the difference in at least one motion vector component between blocks on respective side of the boundary is equal to or greater than a threshold of 1 sample. In VTM, a threshold of a half luma sample is introduced to also enable removal of blocking artifacts originating from boundaries between inter prediction units that have a small difference in motion vectors.

### 2.8 Luma Mapping with Chroma Scaling (LMCS)

In VVC, a coding tool called the luma mapping with chroma scaling (LMCS) is added as a new processing block before the loop filters. LMCS has two main components: 1) in-loop mapping of the luma component based on adaptive piecewise linear models; 2) for the chroma components, luma-dependent chroma residual scaling is applied. FIG. 12 illustrates an example luma mapping with chroma scaling architecture. FIG. 12 shows the LMCS architecture from decoder's perspective. The shaded blocks 1202 in FIG. 12 indicate where the processing is applied in the mapped domain; and these include the inverse quantization, inverse transform, luma intra prediction and adding of the luma prediction together with the luma residual. The unshaded blocks in FIG. 12 indicate where the processing is applied in the original (i.e., non-mapped) domain; and these include loop filters such as deblocking, ALF, and SAO, motion compensated prediction, chroma intra prediction, adding of the chroma prediction together with the chroma residual, and storage of decoded pictures as reference pictures. The shaded blocks 1204 in FIG. 12 are the new LMCS functional blocks, including forward and inverse mapping of the luma signal and a luma-dependent chroma scaling process. Like most other tools in VVC, LMCS can be enabled/disabled at the sequence level using an SPS flag.

### 2.8.1 Luma Mapping with Piecewise Linear Model

The in-loop mapping of the luma component adjusts the dynamic range of the input signal by redistributing the codewords across the dynamic range to improve compression efficiency. Luma mapping makes use of a forward mapping function, FwdMap, and a corresponding inverse mapping function, InvMap. The FwdMap function is signalled using a piecewise linear model with 16 equal pieces. InvMap function does not need to be signalled and is instead derived from the FwdMap function.

The luma mapping model is signalled in the adaptation parameter set (APS) syntax structure with aps_params_type set equal to 1 (LMCS_APS). Up to 4 LMCS APS's can be used in a coded video sequence. Only 1 LMCS APS can be used for a picture. The luma mapping model is signalled using piecewise linear model. The piecewise linear model partitions the input signal's dynamic range into 16 equal pieces, and for each piece, its linear mapping parameters are expressed using the number of codewords assigned to that piece. Take 10-bit input as an example. Each of the 16 pieces will have 64 codewords assigned to it by default. The signalled number of codewords is used to calculate the scaling factor and adjust the mapping function accordingly for that piece. At the slice level, an LMCS enable flag is signalled to indicate if the LMCS process as depicted in FIG. 12 is applied to the current slice. If LMCS is enabled for the current slice, an aps_id is signaled in the slice header to identify the APS that carries the luma mapping parameters.

Each i-th piece, i=0 . . . 15, of the FwdMap piecewise linear model is defined by two input pivot points InputPivot[ ] and two output (mapped) pivot points MappedPivot[ ].

The InputPivot[ ] and MappedPivot[ ] are computed as follows (assuming 10-bit video):
1) OrgCW=64
2) For i=0:16, InputPivot[i]=i*OrgCW
3) For i=0:16, MappedPivot[i] is calculated as follows:

$$MappedPivot [ 0 ] = 0 ;$$

$$for ( i = 0 ; i < 16 ; i + + )$$

$$MappedPivot [ i + 1 ] = MappedPivot [ i ] + SignalledCW [ i ]$$

where SignalledCW[i] is the signalled number of codewords for the i-th piece.

As shown in FIG. 12, for an inter-coded block, motion compensated prediction is performed in the mapped domain. In other words, after the motion-compensated prediction block Y_{pred} is calculated based on the reference signals in the decoded picture buffer (DPB), the FwdMap function is applied to map the luma prediction block in the original domain to the mapped domain, Y′_{pred}=FwdMap(Y_{pred}). For an intra-coded block, the FwdMap function is not applied because intra prediction is performed in the mapped domain. After reconstructed block Yᵣ is calculated, the InvMap function is applied to convert the reconstructed luma values in the mapped domain back to the reconstructed luma values in the original domain (Ŷᵢ=InvMap(Yᵣ)). The InvMap function is applied to both intra- and inter-coded luma blocks.

The luma mapping process (forward and/or inverse mapping) can be implemented using either look-up-tables (LUT) or using on-the-fly computation. If LUT is used, then FwdMapLUT and InvMapLUT can be pre-calculated and pre-stored for use at the tile group level, and forward and inverse mapping can be simply implemented as FwdMap(Y_{pred})=FwdMapLUT[Y_{pred}] and InvMap(Yᵣ)=InvMapLUT[Yᵣ], respectively. Alternatively, on-the-fly computation may be used. Take forward mapping function FwdMap as an example. In order to figure out the piece to which a luma sample belongs, the sample value is right shifted by 6 bits (which corresponds to 16 equal pieces). Then, the linear model parameters for that piece are retrieved and applied on-the-fly to compute the mapped luma value. Let i be the piece index, a1, a2 be InputPivot[i] and InputPivot[i+1], respectively, and b1, b2 be MappedPivot[i] and MappedPivot[i+1], respectively. The FwdMap function is evaluated as follows:

$$F wdMap ( {Y}_{p r e d} ) = ( ( b 2 - b 1 ) / ( a 2 - a 1 ) ) * ( {Y}_{p r e d} - a 1 ) + b 1 \qquad ( 3 - 22 )$$

The InvMap function can be computed on-the-fly in a similar manner. Generally, the pieces in the mapped domain are not equal sized, therefore the most straightforward inverse mapping process would require comparisons in order to figure out to which piece the current sample value belongs. Such comparisons increase decoder complexity. For this reason, VVC imposes a bitstream constraint on the values of the output pivot points MappedPivot[i] as follows. Assume the range of the mapped domain (for 10-bit video, this range is [0, 1023]) is divided into 32 equal pieces. If MappedPivot[i] is not a multiple of 32, then MappedPivot[i+1] and MappedPivot[i] cannot belong to the same piece of the 32 equal-sized pieces, i.e., MappedPivot[i+1]>>(BitDepthY−5) shall not be equal to MappedPivot[i]>>(BitDepthY−5). Thanks to such bitstream constraint, the InvMap function can also be carried out using a simple right bit-shift by 5 bits (which corresponds 32 equal-sized pieces) in order to figure out the piece to which the sample value belongs.

### 2.8.2 Luma-Dependent Chroma Residual Scaling

Chroma residual scaling is designed to compensate for the interaction between the luma signal and its corresponding chroma signals. Whether chroma residual scaling is enabled or not is also signalled at the slice level. If luma mapping is enabled, an additional flag is signalled to indicate if luma-dependent chroma residual scaling is enabled or not. When luma mapping is not used, luma-dependent chroma residual scaling is disabled. Further, luma-dependent chroma residual scaling is always disabled for the chroma blocks whose area is less than or equal to 4.

Chroma residual scaling depends on the average value of top and/or left reconstructed neighboring luma samples of the current VPDU. If the current CU is inter 128×128, inter 128×64 and inter 64×128, then the chroma residual scaling factor derived for the CU associated with the first VPDU is used for all chroma transform blocks in that CU. Denote avgYr as the average of the reconstructed neighboring luma samples (see FIG. 12). The value of C_{ScaleInv} is computed in the following steps:
1) Find the index Y_{Idx} of the piecewise linear model to which avgYr belongs based on the InvMap function.
2) C_{ScaleInv}=cScaleInv[Y_{Idx}], where cScaleInv[ ] is a 16-piece LUT pre-computed based on the value of SignalledCW[i] and an offset value signalled in APS for chroma residual scaling process.

Unlike luma mapping, which is performed on the sample basis, C_{ScaleInv} is a constant value for the entire chroma block. With C_{ScaleInv}, chroma residual scaling is applied as follows:

$$Encoder side : {C}_{ResScale} = {C}_{Res} * {C}_{Scale} = {C}_{Res} / {C}_{ScaleInv}$$

$$Decoder side : {C}_{Res} = {C}_{ResScale} / {C}_{Scale} = {C}_{ResScale} * {C}_{ScaleInv}$$

### 2.8.3 Encoder-Side LMCS Parameter Estimation

A non-normative reference implementation is provided in the VTM encoder to estimate the LMCS model parameters. Because VTM anchors handle standard dynamic range (SDR), high dynamic range (HDR) perceptual quantizer (PQ) and HDR hybrid log gamma (HLG) differently, the reference algorithm in VTM11 is designed differently for SDR, HDR PQ and HDR HLG sequences. For SDR and HDR HLG sequences, the encoder algorithm is based on local luma variance and optimized for peak signal-to-noise ratio (PSNR) metrics. For HDR PQ sequences, the encoder algorithm is based on luma values and optimized for weighted PSNR (wPSNR) metrics.

### 2.8.3.1 LMCS Parameter Estimation for SDR

The basic idea of the VTM11 reference implementation for SDR is to assign pieces with more codewords to those dynamic range segments that have lower than average variance, and to assign fewer codewords to those dynamic range segments that have higher than average variance. In this way, smooth areas of the picture will be coded with more codewords than average, and vice versa. For SDR, VTM11 provides a reference algorithm and also configurable LMCS parameters for user tuning.

For SDR test sequences, the reference algorithm performs the following signal analysis:
1) Statistics of the input video are collected and analyzed assuming 10-bit internal coding bit-depth is used. If the internal coding bit-depth is not 10-bit, then bit-depth is first normalized to 10-bit.
2) Divide the dynamic range of [0, 1023] into 16 equal pieces.
3) For each luma sample location in the picture, the local spatial variance of luma sample values is calculated using a winSize×winSize (winSize=└min(width, height)/240┘*2+1) neighborhood centered on the current position. Denote the specific piece (out of the 32 pieces) to which the current luma sample value belongs as p. This local variance is thus associated with the p-th piece.
4) For each of the 16 pieces, calculate the average local spatial variance (bin_var)
5) For all valid pieces, an equal number of codewords per piece is allocated;

$$binCW [ i ] = round ( \frac{totalCW}{endIdx - startIdx + 1} ) ,$$

where binCW[i] is the number of codewords allocated to the i-th piece, totalCW is the total number of codewords allowed, and startIdx and endIdx are the index values for the first and last valid piece, respectively.
6) The allocation of codewords is adjusted such that more codewords are allocated to pieces with lower average local spatial variance and fewer codewords are allocated to pieces with higher average local variance; if normVar<1.0,

$$binCW [ i ] = \{ \begin{matrix}binC W [ i ] + d e lta 1 , & 0.8 \leq normVar < 0.9 \\ binC W [ i ] + d e lta 2 , & normVar < 0.8\end{matrix} \qquad ( 2 - 23 )$$

$$else if normVar > 1. ,$$

$$binCW [ i ] = \{ \begin{matrix}binC W [ i ] - d e lta 1 , & 1.1 < normVar \leq 1.2 \\ binC W [ i ] - d e lta 2 , & normVar > 1.2\end{matrix} \qquad ( 2 - 24 )$$

where normVar=binVar[i]/meanVar, delta1=round (10*hist), delta2=round (20*hist), where binVar[i] is the average local spatial variance for the luma values in the i-th piece; meanVar is the mean of the average local spatial variances across all valid pieces; and hist is the percentage of samples in the i-th piece over the total number of samples, clipped to the range of [0, 0.4] to avoid aggressive codeword assignment.
7) If the total number of codewords allocated exceeds the maximum number of allowed codewords. the total number of codewords is reduced by equal amount starting from the first piece.
8) Adaptation decisions are made to set LMCS slice type, high bit rate, and chroma adjust adaptation parameters based on the relative histogram and average local spatial variances of the luma signal before and after reshaping. Slice type adaptation refers to enabling LMCS for the follow slice type combinations: intra and inter; pictures with temporal-ID 0 only; or inter only. High bit rate adaptation refers to adjusting the number of codewords allocated to pieces for QP values less than or equal to 22. Chroma adjustment adaptation refers to disabling or enabling chroma residue scaling. All these adaptation decisions are based on a series of threshold comparisons.
9) The SignalledCW[i] values are signalled in an LMCS APS.

When LMCS is applied, sum square error (SSE) is used for luma for intra (I) slices and weighted SSE is used for luma for inter (P or B) slices. The weight, w_Imcs(k), is derived as follows based on the codeword assignment of the k-th piece in the piecewise linear model.

$$w\_lmcs [ k ] = ( SignalledC W [ k ] / OrgCW ) \hat{} 2 \qquad ( 2 - 25 )$$

SSE is always used for chroma mode decision.

In terms of picture-level decision whether to enable LMCS or not, different considerations are given to the different coding configurations. For the Random Access (RA) test conditions, picture analysis is performed for each intra random access point (IRAP) picture as explained above. Then, if the average local spatial variance of the original picture is large, or if the average local variance of the mapped picture is large compared to the original, then LMCS is disabled for intra. For the other inter-coded pictures in the same IRAP period, if LMCS is enabled for the IRAP picture, then LMCS is enabled only for the pictures with temporal layer ID equal to 0. Otherwise, if LMCS is disabled for the IRAP picture, then LMCS is enabled for all the inter-coded pictures.

For All Intra (AI) and low delay (LD) test conditions, LMCS is enabled for all pictures. For AI, the LMCS parameter estimation is performed for all coded pictures, and the model parameters are updated in LMCS APS for all coded pictures. For LD, the LMCS parameters are estimated at every second interval, and the model parameters are updated in the LMCS APS at the instances of those pictures.

### 2.8.3.2 LMCS Parameter Estimation for HDR

In the JVET HDR common test conditions (CTC), two types of HDR sequences are included: PQ and HLG. These two types of sequences are treated differently in the VTM reference encoder. For the PQ sequences, the VTM reference encoder applies luma-based QP adaptation and allows the QP value to vary spatially. For the HLG sequences, static quantization is used. Correspondingly, LMCS is applied differently for these two types of sequences as well. For PQ, LMCS is applied using a default LMCS mapping function calculated as explained below. For HLG, LMCS parameter estimation algorithm similar to that for SDR is applied.

The VTM reference encoder uses wPSNR instead of the conventional PSNR as an objective quality metric in the HDR PQ CTC. The default HDR PQ LMCS curve is calculated to match the delta QP (dQP) function to maximize the wPSNR metric.

The luma-based QP adaptation derives a local dQP value per CTU based on the average of luma sample values:

$$dQP ( Y ) = max ( - 3 , min ( 6 , 0.015 * Y - 1.5 - 6 ) ) \qquad ( 2 - 26 )$$

where Y is the average luma value, Y∈[0,maxY], max Y=1023 for 10-bit video. The weight (W_SSE) used in wPSNR calculation is derived based on dQP values:

$$W\_SSE ( Y ) = 2 \hat{} ( dQP ( Y ) / 3 ) \qquad ( 2 - 27 )$$

The default LMCS curve is calculated based on luma sample value as follows:
1) Compute the slope of the reshaping curve: slope[Y]=sqrt (W_SSE (Y))=2\hat{ }(dQP(Y)/6).
2) If signal is in narrow range (also called a standard range), set slope[Y]=0 for Y∈[0,64), or Y∈(940,1023].
3) Calculate F[Y] by integrating slope[Y], F[Y+1]=F[Y]+slope[Y], Y=0 . . . maxY−1
4) FwdLUT[Y] is calculated by normalizing F[Y] to [0 maxY], FwdLUT[Y]=clip3(0, maxY, round(F[Y]*max Y/F[max Y])).
5) Calculate the number of codewords for the 16 equal pieces SignalledCW[i], i=0 . . . 15, as follows:

$$SignalledC W [ 15 ] = F w d L U T [ 1023 ] - FwdLUT [ 960 ] ;$$

$$for ( i = 14 ; i >= 0 ; i - - )$$

$$SignalledCW [ i ] = FwdLUT [ ( i + 1 ) * OrgCW ] - FwdLUT [ i * OrgCW ] ;$$

In terms of rate distortion optimized mode decision at the encoder, when LMCS is applied, for an intra (I) slice, SSE is used for luma and weighted SSE is used for chroma as the distortion measure. For an inter (P or B) slice, weighted SSE is used for both luma and chroma. LMCS is applied to all slices.

### 2.9 Sample Adaptive Offset (SAO)

Sample adaptive offset (SAO) is applied to the reconstructed signal after the deblocking filter by using offsets specified for each CTB by the encoder. The HEVC test model (HM) encoder first makes the decision on whether the SAO process is to be applied for current slice. If SAO is applied for the slice, each CTB is classified as one of five SAO types as shown in Table 6. The concept of SAO is to classify pixels into categories and reduces the distortion by adding an offset to pixels of each category. SAO operation includes edge offset (EO) which uses edge properties for pixel classification in SAO type 1 to 4 and band offset (BO) which uses pixel intensity for pixel classification in SAO type 5. Each applicable CTB has SAO parameters including sao_merge_left_flag, sao_merge_up_flag, SAO type and four offsets. If sao_merge_left_flag is equal to 1, the current CTB will reuse the SAO type and offsets of the CTB to the left. If sao_merge_up_flag is equal to 1, the current CTB will reuse SAO type and offsets of the CTB above.

TABLE 6
Specification of SAO type

| SAO | | Number of |
|---|---|---|
| type | sample adaptive offset type to be used | categories |
| 0 | None | 0 |
| 1 | 1-D 0-degree pattern edge offset | 4 |
| 2 | 1-D 90-degree pattern edge offset | 4 |
| 3 | 1-D 135-degree pattern edge offset | 4 |
| 4 | 1-D 45-degree pattern edge offset | 4 |
| 5 | band offset | 4 |

### 2.9.1 Operation of Each SAO Type

FIG. 13 illustrates an example four 1-D 3-pixel patterns for the pixel classification in EO. Edge offset uses four 1-D 3-pixel patterns for classification of the current pixel p by consideration of edge directional information d, as shown in FIG. 13. From left to right these are: 0-degree, 90-degree, 135-degree and 45-degree. Each CTB is classified into one of five categories according to Table 7.

TABLE 7
Pixel classification rule for EO

| Category | Condition | Meaning |
|---|---|---|
| 0 | None of the below | Largely monotonic |
| 1 | p < 2 neighbors | Local minimum |
| 2 | p < 1 neighbor && p == 1 neighbor | Edge |
| 3 | p > 1 neighbor && p == 1 neighbor | Edge |
| 4 | p > 2 neighbors | Local maximum |

FIG. 14 illustrates an example of four bands are grouped together and represented by its starting band position. Band offset (BO) classifies all pixels in one CTB region into 32 uniform bands by using the five most significant bits of the pixel value as the band index. In other words, the pixel intensity range is divided into 32 equal segments from zero to the maximum intensity value (e.g., 255 for 8-bit pixels). Four adjacent bands are grouped together, and each group is indicated by its most left-hand position as shown in FIG. 14. The encoder searches all positions to get the group with the maximum distortion reduction by compensating offset of each band.

### 2.10 Adaptive Loop Filter in ECM

### 2.10.1 ALF Simplification Removal

ALF gradient subsampling and ALF virtual boundary processing are removed. Block size for classification is reduced from 4×4 to 2×2. Filter size for both luma and chroma, for which ALF coefficients are signalled, is increased to 9×9.

### 2.10.2 ALF with Fixed Filters

To filter a luma sample, three different classifiers (C0, C1, and C2) and three different sets of filters (F0, F1, and F2) are used. Sets F0 and F1 contain fixed filters, with coefficients trained for classifiers C0 and C1. Coefficients of filters in F2 are signalled. Which filter from a set Fi is used for a given sample is decided by a class Cᵢ assigned to this sample using classifier Ci.

### 2.10.3 Filtering

At first, two 13×13 diamond shape fixed filters F0 and F1 are applied to derive two intermediate samples R₀(x,y) and R₁(x,y). After that, F2 is applied to R₀(x,y), R₁(x,y), and neighboring samples to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] , \qquad ( 2 - 28 )$$

where f_{i,j} is the clipped difference between a neighboring sample and current sample R(x,y) and gᵢ is the clipped difference between Rᵢ₋₂₀(x,y) and current sample. The filter coefficients cᵢ, i=0, . . . 21, are signalled.

### 2.10.4 Classification

Based on directionality Dᵢ and activity Âᵢ, a class Cᵢ is assigned to each 2×2 block:

$${C}_{i} = {\hat{A}}_{i} * {M}_{D , i} + {D}_{i} \qquad ( 2 - 29 )$$

where M_{D,i} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C0 and the sum of sample gradients within a 12×12 window is used for classifiers C1 and C2. The sums of horizontal, vertical and two diagonal gradients are denoted, respectively, as gₕⁱ,gᵥⁱ,g_{d1}ⁱ, and g_{d2}ⁱ. The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} \qquad ( 2 - 30 )$$

with a set of thresholds. The directionality D₂ is derived as in VVC using thresholds 2 and 4.5. For D₀ and D₁, horizontal/vertical edge strength E_{HV}ⁱ and diagonal edge strength E_{D}ⁱ are calculated first. Thresholds Th=[1.25,1.5,2,3,4.5,8] are used. Edge strength E_{HV}ⁱ is 0 if r_{h,v}ⁱ≤ Th[0]; otherwise, E_{HV}ⁱ is the maximum integer such that r_{h,v}ⁱ>Th[E_{HV}ⁱ−1]. Edge strength E_{D}ⁱ is 0 if r_{d1,d2}ⁱ≤Th[0]; otherwise, E, is the maximum integer such that r_{d1,d2}ⁱ>Th[E_{D}ⁱ−1]. When r_{h,v}ⁱ>r_{d1,d2}ⁱ, i.e., horizontal/vertical edges are dominant, the Dᵢ is derived by using Table 8(a); otherwise, diagonal edges are dominant, the Dᵢ is derived by using Table 8 (b).

TABLE 8
Mapping of E_{D}ⁱ and E_{HV}ⁱ to Dᵢ
(a)

| | E_{D}ⁱ | | | | | | |
|---|---|---|---|---|---|---|---|
| E_{HV}ⁱ | 0 | 1 | 2 | 3 | 4 | 5 | 6 |
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

(b)

| | E_{HV}ⁱ | | | | | | |
|---|---|---|---|---|---|---|---|
| E_{D}ⁱ | 0 | 1 | 2 | 3 | 4 | 5 | 6 |
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁. In an ALF_APS, up to 4 luma filter sets are signalled, each set may have up to 25 filters.

### 2.10.5 Alternative 2×2 ALF Classifier

Classification in ALF is extended with an additional alternative classifier. For a signalled luma filter set, a flag is signalled to indicate whether the alternative classifier is applied. Geometrical transformation is not applied to the alternative band classifier. When the band-based classifier is applied, the sum of sample values of a 2×2 luma block is calculated at first. Then the class index is calculated as below,

$$class\_index = ( sum * 25 ) ≫ ( samples bit depth + 2 ) \qquad ( 2 - 31 )$$

### 2.10.6 CCALF with Long Tap Filter

FIG. 15 illustrates an example 25-tap long filter. The CCALF process uses a linear filter to filter luma sample values and generate a residual correction for the chroma samples. A 25-tap large filter is used in CCALF process, which is illustrated in FIG. 15. For a given slice, the encoder can collect the statistics of the slice, analyze them and can signal up to 16 filters through APS.

### 2.11 Bilateral Filter

FIG. 16 illustrates an example of both BIF and SAO use samples from the deblocking stage as input. Both create an offset, and these are added to the input sample and clipped. The filter is carried out in the SAO loop-filter stage, as shown in FIG. 16. Both the BIF and SAO are using samples from deblocking as input. Each filter creates an offset per sample, and these are added to the input sample and then clipped, before proceeding to ALF.

Both BIF and SAO use samples from the deblocking stage as input. Both create an offset, and these are added to the input sample and clipped. In detail, the output sample I_{OUT} is obtained as

$${I}_{OUT} = clip 3 ( {I}_{C} + Δ {I}_{BIF} + Δ {I}_{SAO} ) , \qquad ( 2 - 32 )$$

where I_{C} is the input sample from deblocking, ΔI_{BIF} is the offset from the bilateral filter and ΔI_{SAO} is the offset from SAO. The implementation provides the possibility for the encoder to enable or disable filtering at the CTU and slice level. The encoder takes a decision by evaluating the RDO cost.

FIG. 17 illustrates an example naming convention for samples surrounding the center sample, I_C. For CTUs that are filtered, the filtering process proceeds as follows. At the picture border, where samples are unavailable, the bilateral filter uses extension (sample repetition) to fill in unavailable samples. For virtual boundaries, the behavior is the same as for SAO, i.e., no filtering occurs. When crossing horizontal CTU borders, the bilateral filter can access the same samples as SAO is accessing. As an example, if the center sample I_{C} in FIG. 17 is located on the top line of a CTU, I_{NW}, I_{A} and I_{NE} are read from the CTU above, as with SAO, but I_{AA} is padded, so no extra line buffer is needed.

The samples surrounding the center sample I_{C} are denoted according to FIG. 17, in which A, B, L, and R stand for above, below, left, and right, respectively, and NW, NE, SW, SE stand for northwest (i.e., above-left), northeast (i.e., above-right), southwest (i.e., below-left), and southeast (i.e., below-right), respectively. Likewise, AA stands for above-above, BB stands for below-below, LL stands for left-left, and RR stands for right-right. This diamond shape is different a square filter support which is not using I_{AA}, I_{BB}, I_{LL}, Or I_{RR}.

Each surrounding sample I_{A}, I_{R} etc will contribute with a corresponding modifier value μ_{ΔI}_{_{A}}, μ_{ΔI}_{_{R}}, etc. These are calculated the following way: Starting with the contribution from the sample to the right, I_{R}, a difference is calculated:

$$Δ {I}_{R} = ( \vert {I}_{R} - {I}_{C} \vert + 4 ) ≫ 3 , \qquad ( 2 - 33 )$$

where |·| denotes absolute value. For data that is not 10-bit, the following is instead used, ΔI_{R}=(|I_{R}−I_{C}|+2ⁿ⁻⁶)>>(n−7), where n=8 for 8-bit data, etc. The resulting value is now clipped so that it is less than 16:

$${sI}_{R} = min ( 15 , Δ {I}_{R} ) . \qquad ( 2 - 34 )$$

The modifier value is now calculated as:

$${μ}_{Δ {I}_{R}} = \{ \begin{matrix}{LUT}_{ROW} [ {sI}_{R} ] , & if {I}_{R} - {I}_{C} \geq 0 , \\ - {LUT}_{ROW} [ {sI}_{R} ] & otherwise\end{matrix} \qquad ( 2 - 35 )$$

where LUT_{ROW}[ ] is an array of 16 values determined by the value of qpb=clip (0, 25, QP+bilateral_filter_qp_offset−17):
{0, 0, 0, 0, 0, 0, 0, 0, 0, 0, 0, 0, 0, 0, 0, 0,}, if qpb=0
{0, 1, 1, 1, 1, 0, 0, 0, 0, 0, 0, 0, 0, 0, 0, 0,}, if qpb=1
{0, 2, 2, 2, 1, 1, 0, 1, 0, 0, 0, 0, 0, 0, 0, 0,}, if qpb=2
{0, 2, 2, 2, 2, 1, 1, 1, 1, 1, 1, 1, 0, 1, 1, −1,}, if qpb=3
{0, 3, 3, 3, 2, 2, 1, 2, 1, 1, 1, 1, 0, 1, 1, −1,}, if qpb=4
{0, 4, 4, 4, 3, 2, 1, 2, 1, 1, 1, 1, 0, 1, 1, −1,}, if qpb=5
{0, 5, 5, 5, 4, 3, 2, 2, 2, 2, 2, 1, 0, 1, 1, −1,}, if qpb=6
{0, 6, 7, 7, 5, 3, 3, 3, 3, 2, 2, 1, 1, 1, 1, −1,}, if qpb=7
{0, 6, 8, 8, 5, 4, 3, 3, 3, 3, 3, 2, 1, 2, 2, −2,}, if qpb=8
{0, 7, 10, 10, 6, 4, 4, 4, 4, 3, 3, 2, 2, 2, 2, −2,}, if qpb=9
{0, 8, 11, 11, 7, 5, 5, 4, 5, 4, 4, 2, 2, 2, 2, −2,}, if qpb=10
{0, 8, 12, 13, 10, 8, 8, 6, 6, 6, 5, 3, 3, 3, 3, −2,}, if qpb=11
{0, 8, 13, 14, 13, 12, 11, 8, 8, 7, 7, 5, 5, 4, 4, −2,}, if qpb=12
{0, 9, 14, 16, 16, 15, 14, 11, 9, 9, 8, 6, 6, 5, 6, −3,}, if qpb=13
{0, 9, 15, 17, 19, 19, 17, 13, 11, 10, 10, 8, 8, 6, 7, −3,}, if qpb=14
{0, 9, 16, 19, 22, 22, 20, 15, 12, 12, 11, 9, 9, 7, 8, −3,}, if qpb=15
{0, 10, 17, 21, 24, 25, 24, 20, 18, 17, 15, 12, 11, 9, 9, −3,}, if qpb=16
{0, 10, 18, 23, 26, 28, 28, 25, 23, 22, 18, 14, 13, 11, 11, −3,}, if qpb=17
{0, 11, 19, 24, 29, 30, 32, 30, 29, 26, 22, 17, 15, 13, 12, −3,}, if qpb=18
{0, 11, 20, 26, 31, 33, 36, 35, 34, 31, 25, 19, 17, 15, 14, −3,}, if qpb=19
{0, 12, 21, 28, 33, 36, 40, 40, 40, 36, 29, 22, 19, 17, 15, −3,}, if qpb=20
{0, 13, 21, 29, 34, 37, 41, 41, 41, 38, 32, 23, 20, 17, 15, −3,}, if qpb=21
{0, 14, 22, 30, 35, 38, 42, 42, 42, 39, 34, 24, 20, 17, 15, −3,}, if qpb=22
{0, 15, 22, 31, 35, 39, 42, 42, 43, 41, 37, 25, 21, 17, 15, −3,}, if qpb=23
{0, 16, 23, 32, 36, 40, 43, 43, 44, 42, 39, 26, 21, 17, 15, −3,}, if qpb=24
{0, 17, 23, 33, 37, 41, 44, 44, 45, 44, 42, 27, 22, 17, 15, −3,}, if qpb=25

These values can be stored using six bits per entry resulting in 26*16*6/8=312 bytes or 300 bytes if excluding the first row which is all zeros. The modifier values for μ_{ΔI}_{_{L}}, μ_{ΔI}_{_{A}}, and μ_{ΔI}_{_{B}} are calculated from I_{L}, I_{A} and I_{B} in the same way. For diagonal samples I_{NW}, I_{NE}, I_{SE}, I_{SW}, and the samples two steps away I_{AA}, I_{BB}, I_{RR} and I_{LL}, the calculation also follows Equations (2-33) and (2-34), but uses a value shifted by 1. Using the diagonal sample I_{SE} as an example:

$${μ}_{Δ {I}_{SE}} = \{ \begin{matrix}{LUT}_{ROW} [ {sI}_{SE} ] ≫ 1 , & if {I}_{SE} - {I}_{C} \geq 0 , \\ - {LUT}_{ROW} [ {sI}_{SE} ] ≫ 1 ) & otherwise\end{matrix} \qquad ( 2 - 36 )$$

and the other diagonal samples and two-steps-away samples are calculated likewise. The modifier values are summed together:

$${m}_{sum} = {μ}_{Δ {I}_{A}} + {μ}_{Δ {I}_{B}} + {μ}_{Δ {I}_{L}} + {μ}_{Δ {I}_{R}} + {μ}_{Δ {I}_{NW}} + {μ}_{Δ {I}_{NE}} + {μ}_{Δ {I}_{SW}} + {μ}_{Δ {I}_{SE}} + {μ}_{Δ {I}_{AA}} + {μ}_{Δ {I}_{BB}} + {μ}_{Δ {I}_{LL}} + {μ}_{Δ {I}_{RR}} . \qquad ( 2 - 37 )$$

Note that μ_{ΔI}_{_{R}} equals −μ_{ΔI}_{_{A}} for the previous sample. Likewise, μ_{ΔI}_{_{A}}, equals −μ_{ΔI}_{_{B}} for the sample above, and similar symmetries can be found also for the diagonal- and two-steps-away modifier values. This means that in a hardware implementation, it is sufficient to calculate the six values μ_{ΔI}_{_{R}}, μ_{ΔI}_{_{B}}, μ_{ΔI}_{_{SW}}, μ_{ΔI}_{_{SE}}, μ_{ΔI}_{_{RR}} and μ_{ΔI}_{_{BB}} and the remaining six values can be obtained from previously calculated values.

The mₛᵤₘ value is now multiplied either by c=1, 2 or 3, which can be done using a single adder and logical AND gates in the following way:

$${c}_{v} = {k}_{1} \& ( {m}_{sum} ≪ 1 ) + {k}_{2} \& {m}_{sum} , \qquad ( 2 - 38 )$$

where & denotes logical AND, k₁ is the most significant bit of the multiplier c, and k₂ is the least significant bit. The value to multiply with is obtained using the minimum block dimension D=min (width, height) as shown in Table 9:

TABLE 9
Obtaining the c parameter from the minimum size
D = min(width, height) of the block.

| Block type | D ≤ 4 | 4 < D < 16 | D ≥ 16 |
|---|---|---|---|
| Intra | 3 | 2 | 1 |
| Inter | 2 | 2 | 1 |

Finally, the bilateral filter offset ΔI_{BIF} is calculated. For full strength filtering:

$$Δ {I}_{BIF} = ( {c}_{v} + 16 ) ≫ 5 , \qquad ( 2 - 39 )$$

whereas for half-strength filtering:

$$Δ {I}_{BIF} = ( {c}_{v} + 32 ) ≫ 6. \qquad ( 2 - 40 )$$

A general formula for n-bit data is to use:

$${r}_{add} = {2}^{14 - n - bilateral \_ filter \_ strength} \qquad ( 2 - 41 )$$

$${r}_{shift} = 15 - n - bilateal\_filter \_strength$$

$$Δ {I}_{BIF} = ( {c}_{v} + {r}_{add} ) ≫ {r}_{shift} ,$$

where bilateral_filter_strength can be 0 or 1 and is signalled in the picture parameter set (PPS).

### 2.12 Bilateral In-Loop Filter on Chroma

FIG. 18 illustrates an example filtering stage of BIF-Chroma. As with BIF-luma, an example BIF-chroma is also performed in parallel with the SAO and CCSAO process as shown in FIG. 18. BIF-chroma, CCSAO and SAO use the same chroma samples produced by the deblocking filter as input and generate three offsets per chroma sample in parallel. Then, these three offsets are added to the input chroma sample to obtain a sum, which is then clipped to form the final output chroma sample value. The proposed BIF-chroma provides an on/off control mechanism on CTU level and slice level.

The filtering process of BIF-chroma is similar to that of BIF-luma. For a chroma sample, a 5×5 diamond shape filter is used for generating the filtering offset. The difference between the central sample and each surrounding sample is calculated first. The coefficient for each reference sample is extracted from a pre-defined look-up-table based on the calculated difference directly. The coefficients used for chroma components are retrained, different from those from BIF-luma. In the BIF-luma design, the block-level filtering strength parameter c is determined based on luma TU size and CU mode. While in the BIF-chroma design, the parameter for chroma components is determined based the chroma TU size and mode when dual-tree partitioning is enabled for the current slice and based on the corresponding luma TU size and mode when dual-tree partitioning is disabled.

### 2.13 Cross-Component Sample Adaptive Offset (CCSAO)

FIG. 19 illustrates an example modified SAO process when the proposed CCSAO is applied. For example, CCSAO is used to refine reconstructed chroma samples. Similarly to SAO, the CCSAO classifies the reconstructed samples into different categories, derives one offset for each category and adds the offset to the reconstructed samples in that category. However, different from SAO which only uses one single luma/chroma component of current sample as input, the CCSAO utilizes all three components to classify the current sample into different categories. To facilitate the parallel processing, the output samples from the de-blocking filter are used as the input of the CCSAO. FIG. 19 shows the diagram of the decoding workflow when the CCSAO is applied.

FIG. 20 illustrates an example of the candidate positions used for the CCSAO classifier 500. For example, a co-located and neighboring luminance (brightness) component Y 502 is classified using a co-located chrominance (color) component U 504, a co-located chrominance (color) component Y 506, and/or the neighboring pixels/samples 508. In CCSAO, only BO is used to enhance the quality of the reconstructed samples. For a given luma/chroma sample, three candidate samples are selected to classify the given sample into different categories: one collocated Y sample, one collocated U sample, and one collocated V sample. The sample values of these three selected samples are then classified into three different bands {band_{Y}, band_{U}, band_{V}}, and a joint index i represents the category of the given sample. One offset is signaled and added to the reconstructed samples that fall into that category, which can be formulated as:

$${band}_{Y} = ( {Y}_{col} \cdot {N}_{Y} ) ≫ BD \qquad ( 2 - 42 )$$

$${band}_{U} = ( {U}_{col} \cdot {N}_{U} ) ≫ BD$$

$${band}_{V} = ( {V}_{col} \cdot {N}_{V} ) ≫ BD$$

$$i = {band}_{Y} \cdot ( {N}_{U} \cdot {N}_{V} ) + {band}_{U} \cdot {N}_{V} + {band}_{V}$$

$${C}_{rec}^{′} = Clip 1 ( {C}_{rec} + {σ}_{CCSAO} [ i ] )$$

where {Y_{col}, U_{col}, V_{col}} are the three selected collocated samples used to classify current sample; {N_{Y}, N_{U}, N_{V}} are the numbers of equally divided bands applied to {Y_{col}, U_{col}, V_{col}} full range respectively; BD is the internal coding bit-depth; C_{rec} and C_{rec}′ are the reconstructed samples before and after the CCSAO is applied; σ_{CCSAO}[i] is the value of the CCSAO offset applied to i-th BO category. The collocated luma sample can be chosen from 9 candidate positions, while the collocated chroma sample positions are fixed, as depicted in FIG. 20.

Similar to SAO, different classifiers can be applied to different local region to further enhance the whole picture quality. The parameters for each classifier (i.e., the position of Y_{col}, N_{Y}, N_{U}, N_{V}, and offsets) are signaled at picture level, and the classifier to be used is explicitly signaled and switched at CTB level. For each classifier, the maximum of {N_{Y}, N_{U}, N_{V}} is set to {16, 4, 4}, and offsets are constrained to be within the range [−15, 15]. At most 4 classifiers are used per frame.

FIG. 21 illustrates an example joint clipping after adding SAO/BIF/CCSAO offsets to the input sample. SAO, BIF, and CCSAO offset are computed in parallel, added to the reconstructed chroma samples and jointly clipped, as shown in FIG. 21.

FIG. 22 illustrates an example four 1-D directional patterns for CCSAO EO sample classification: horizontal (EO class=0), vertical (EO class=1), 135° diagonal, and 45° diagonal. Similar to the edge classifier of SAO in VVC, the edge-based classifier of CCSAO also uses the four 1-D directional patterns for sample classification: horizontal, vertical, 135° diagonal, and 45° diagonal, as shown in FIG. 22.

For every 1-D pattern, each sample is classified based on the sample difference between the luma sample value labeled as “c” and its two neighbor luma samples labeled as “a” and “b” along the selected 1-D pattern.

Similar to SAO, the encoder may decide the best 1-D directional pattern using the rate-distortion optimization (RDO) and signal this additional information in each classifier/set. Both the sample differences “a-c” and “b-c” are compared against a pre-defined threshold value (Th) to derive the final “class_idx” information.

The encoder selects the best “Th” value from an array of pre-defined threshold values based on RDO and the index into the “Th” array is signaled.

Further, an additional difference between CCSAO edge-based classifier and the SAO edge classifier in VVC is that, in the former, Chroma samples use the co-located Luma samples for deriving the edge information (samples “a”, “c” and “b” are the co-located luma samples) whereas, in the later Chroma samples use its own neighboring samples for deriving the edge information.

The Edge-based classifier process is formulated as follows:

$$Ea = ( a - c < 0 ) ? ( a - c < ( - Th ) ? 0 : 1 ) : ( a - c < ( Th ) ? 2 : 3 ) \qquad ( 2 - 43 )$$

$$Eb = ( b - c < 0 ) ? ( b - c < ( - Th ) ? 0 : 1 ) : ( b - c < ( Th ) ? 2 : 3 ) \qquad ( 2 - 44 )$$

$$class\_idx = {i}_{B} * 16 + Ea * 4 + Eb \qquad ( 2 - 45 )$$

$${C}_{rec}^{′} = Clip 1 ( {C}_{rec} + {σ}_{CCSAO} [ class\_idx ] ) \qquad ( 2 - 46 )$$

The variable “i_{B}” in equation (3) is derived as follows:

$${i}_{B} = ( cur \cdot {N}_{cur} ) ≫ BD ( or ) {i}_{B} = ( col 1 \cdot {N}_{col 1} ) ≫ BD ( or ) {i}_{B} = ( col 2 \cdot {N}_{col 2} ) ≫ BD . \qquad ( 2 - 47 )$$

in which, sample “cur” is the current sample being processed, col1 and col2 are the co-located samples. When Luma samples are processed, col1 and col2 are the co-located C_{b} and Cᵣ samples respectively. When Chroma (C_{b}) samples are processed, col1 and col2 are the co-located Y and Cᵣ samples respectively. Similarly, when Chroma (Cᵣ) samples are processed, col1 and col2 are the co-located Y and C_{b} samples respectively.

Based on RDO, encoder signals one among the samples of “cur”, “col1”, “col2” used in deriving the band information.

### 3. TECHNICAL PROBLEMS SOLVED BY DISCLOSED EMBODIMENTS

In example designs for SAO, the parameters (e.g., classification and offsets) are signalled at the CTU level, the overhead of signalling these parameters may limit the coding performance of SAO. In example designs of CCSAO, the parameters (e.g., classification and offsets) are signalled at the picture level, the overhead of signalling these parameters may limit the coding performance of CCSAO. In example designs of CCSAO, the high level syntax (HLS) control flags are signalled for 4:0:0 format which is redundant.

### 5. A LISTING OF SOLUTIONS AND EMBODIMENTS

To solve the above-described problems, methods as summarized below are disclosed. The embodiments should be considered as examples to explain the general concepts and should not be interpreted in a narrow way. Furthermore, these embodiments can be applied individually or combined in any manner. In these embodiments, the terminologies of sample adaptive offset (SAO) and cross-component sample adaptive offset (CCSAO) are not limited to the specific ones defined in example standards or technology. Any variance of the technology is also applicable. Signalling of the parameters of SAO and/or CCSAO

### Example 1

In an example, the parameters of SAO and/or CCSAO can be derived from the pre-defined sets, fixed sets, and/or the adaptive sets. In one example, the parameters of SAO and/or CCSAO may refer to the parameters used for the derivation of classification and/or offsets for different categories. In one example, the adaptive set may refer to the parameters in the set are derived adaptively and/or signalled explicitly in the bitstream.

### Example 2

In one example, which sets are used may be signalled in the bitstream. In one example, a syntax element may be used to indicate which set is used for a video unit.

### Example 3

In one example, the number or the maximum number of the pre-defined/fixed sets and/or the number or the maximum number of the adaptive sets may be pre-defined or signalled in the bitstream. In an example, the number or the maximum number of the pre-defined/fixed sets and/or the number or the maximum number of the adaptive sets may depend on coding information.

### Example 4

In one example, classification mechanisms and/or how to use the offsets in the defined/fixed sets may be same as that in the adaptive sets. In one example, the classification mechanism may refer to the number of categories and/or the derivation of different categories. In one example, the number of categories and/or the maximum number of categories in the pre-defined/fixed sets may be the same as that in the adaptive sets. In one example, the classification mechanism and/or how to use the offsets in the defined/fixed sets may be different from that in the adaptive sets. In one example, the number of categories and/or the maximum number of categories in the pre-defined/fixed sets may be different from that in the adaptive sets.

### Example 5

In one example, the pre-defined/fixed sets may be treated the same as the adaptive sets. In one example, multiple offsets may be derived from one or more pre-defined/fixed sets and/or adaptive sets. In one example, the multiple offsets may be fused and applied to a sample. In one example, one of the multiple offsets may be selected and applied to a sample.

### Example 6

In one example, the adaptive sets of the parameters may be signalled at a sequence level, group of pictures level, picture level, slice level, and/or tile group level, such as in sequence header, picture header, sequence parameter set (SPS), video parameter set (VPS), decoding parameter set (DPS), decoding capability information (DCI), picture parameter set (PPS), adaptation parameter set (APS), slice header, and/or tile group header. In one example, the adaptive sets of the parameters used for SAO may be signalled in APS or picture header. In one example, the adaptive sets of the parameters used for CCSAO may be signalled in APS. In one example, when the adaptive sets of the parameters for SAO and/or CCSAO are signalled in APS, a syntax element indicating which APS the adaptive set is used from may be signalled for a video unit in the bitstream. In one example, the syntax element may refer to APS identifier (id). In one example, a syntax element (such as aps_params_type) in a first APS may be signaled to indicate whether the adaptive sets of the parameters for SAO and/or CCSAO are signalled in the first APS. For example, if the syntax element is equal to a specific value, the parameters for SAO and/or CCSAO are signalled in the first APS. In one example, parameters for SAO and/or CCSAO may be coded in a predictive way. In one example, a first parameter may be predicted by a second parameter signaled in the same video unit (such as APS). In one example, a first parameter may be predicted by a second parameter signaled in a different video unit (such as APS).

### Example 7

In one example, a determination of whether to and/or how to use CCSAO may depend on whether SAO is used. In one example, whether to enable CCSAO for a component may depend on whether SAO is enabled for the component. In one example, the component may refer to luma component. In one example, when luma SAO is disabled, CCSAO is disabled for luma component. In one example, the component may refer to one or more chroma components. In one example, when chroma SAO is disabled for a blue difference chroma (Cb) or red difference chroma (Cr) component, CCSAO is disabled for a Cb or a Cr component. In one example, CCSAO may be disabled when SAO is disabled. In one example, when the SPS flag of SAO is disabled, the SPS flag of CCSAO is not signalled and inferred to be false.

CCSAO for different colour formats

### Example 8

In one example, a determination of whether to and/or how to use CCSAO may depend on the color formats. In one example, CCSAO may be disabled when the color format is 4:0:0. In one example, the syntax elements related to CCSAO may be not signalled when the color format is 4:0:0. In one example, the syntax elements may refer to syntax elements in SPS, and/or in picture header, and/or in slice header. In one example, the syntax elements may be inferred to be a pre-defined value (such as 0) which indicates CCSAO is not applied.

### Example 9

In one example, whether to and/how to use CCSAO may depend on color formats. In one example, the color formats may refer to 4:2:0, or 4:2:2, or 4:4:4. In one example, the determination of classification and/or offsets may be different for different color formats. In one example, the number of categories, and/or the minimum and/or maximum offset value, and/or the threshold used to determine the classification may be different for different color formats. In one example, the chroma samples may be used in edge classifier for 4:2:2 or 4:4:4 color formats. In one example, the candidate positions of collocated luma sample may be different for different color formats.

### Example 10

In above examples, the video unit may refer to a color component, sequence, picture, sub-picture, slice, tile, coding tree unit (CTU), CTU row, groups of CTU, coding unit (CU), prediction unit (PU), transform unit (TU), coding tree block (CTB), coding block (CB), prediction block (PB), transform block (TB), block, sub-block of a block, sub-region within a block, and/or any other region that contains more than one luma or chroma sample/pixel.

### Example 11

Whether to and/or how to apply the disclosed methods above may be signaled in a bitstream. In one example, they may be signaled at sequence level/group of pictures level/picture level/slice level/tile group level, such as in a sequence header, picture header, SPS, VPS, DPS, DCI, PPS, APS, slice header, and tile group header. In one example, they may be signaled at PB, TB, CB, PU, TU, CU, VPDU, CTU, CTU row, slice, tile, sub-picture, other kinds of region contain more than one sample or pixel.

### Example 12

Whether to and/or how to apply the disclosed methods above may be dependent on coded information, such as block size, color format, single/dual tree partitioning, color component, slice/picture type.

### 5. EMBODIMENT

### 5.1 Embodiment 1

### Adaptation Parameter Set RBSP Syntax

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| else if( aps_params_type = = SAO_APS ) | |
| sao_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

| | Descriptor |
|---|---|
| sao_data( ) { | |
| sao_luma_filter_signal_flag | u(1) |
| if( aps_chroma_present_flag ) { | |
| sao_chroma_cb_filter_signal_flag | u(1) |
| sao_chroma_cr_filter_signal_flag | u(1) |
| } | |
| if( sao_luma_filter_signal_flag \|\| | |
| sao_chroma_cb_filter_signal_flag \|\| | |
| sao_chroma_cr_filter_signal_flag ) | |
| sao_max_offset_num | ue(v) |
| if( sao_luma_filter_signal_flag ) { | |
| sao_luma_num_filters_signalled_minus1 | ue(v) |
| for( sfIdx = 0; sfIdx <= | |
| sao_luma_num_filters_signalled_minus1; | |
| sfIdx++ ) | |
| sao_luma_type_idx [ sfIdx ] | u(1) |
| for( j = 0; j < sao_max_offset_num; j++ ) | |
| sao_luma_offset_abs[ sfIdx ][ j ] | ue(v) |
| if( sao_luma_type_idx[ sfIdx ] = = 1 ) { | |
| for( j = 0; j < sao_max_offset_num; j++ ) | |
| if( sao_luma_coeff_abs[ sfIdx ][ j ] ) | |
| sao_luma_offset_sign_flag[ sfIdx ][ j ] | u(1) |
| } | |
| } | |
| if( sao_chroma_cb_filter_signal_flag ) { | |
| sao_chroma_cb_num_filters_signalled_minus1 | ue(v) |
| for( sfIdx = 0; sfIdx <= | |
| sao_chroma_cb_num_filters_signalled_minus1; | |
| sfIdx++ ) | |
| sao_chroma_cb_type_idx [ sfIdx ] | u(1) |
| for( j = 0; j < sao_max_offset_num; j++ ) | |
| sao_chroma_cb_offset_abs[ sfIdx ][ j ] | ue(v) |
| if( sao_chroma_cb_type_idx[ sfIdx ] = = 1 ) { | |
| for( j = 0; j < sao_max_offset_num; j++ ) | |
| if( sao_chroma_cb_coeff_abs[ sfIdx ][ j ] ) | |
| sao_chroma_cb_offset_sign_flag[ | u(1) |
| sfIdx ][ j ] | |
| } | |
| } | |
| if( sao_chroma_cr_filter_signal_flag ) { | |
| sao_chroma_cr_num_filters_signalled_minus1 | ue(v) |
| for( sfIdx = 0; sfIdx <= | |
| sao_chroma_cr_num_filters_signalled_minus1; | |
| sfIdx++ ) | |
| sao_chroma_cr_type_idx [ sfIdx ] | u(1) |
| for( j = 0; j < sao_max_offset_num; j++ ) | |
| sao_chroma_cr_offset_abs[ sfIdx ][ j ] | ue(v) |
| if( sao_chroma_cr_type_idx[ sfIdx ] = = 1 ) { | |
| for( j = 0; j < sao_max_offset_num; j++ ) | |
| if( sao_chroma_cr_coeff_abs[ sfIdx ][ j ] ) | |
| sao_chroma_cb_offset_sign_flag[ | u(1) |
| sfIdx ][ j ] | |
| } | |
| } | |
| } | |

### 5.2 Embodiment 2

### Adaptation Parameter Set RBSP Syntax

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| else if( aps_params_type = = SAO_APS ) | |
| sao_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

| | Descriptor |
|---|---|
| sao_data( ) { | |
| sao_luma_filter_signal_flag | u(1) |
| if( aps_chroma_present_flag ) { | |
| sao_chroma_cb_filter_signal_flag | u(1) |
| sao_chroma_cr_filter_signal_flag | u(1) |
| ccsao_filter_signal_flag | u(1) |
| } | |
| if( sao_luma_filter_signal_flag \|\| | |
| sao_chroma_cb_filter_signal_flag \|\| | |
| sao_chroma_cr_filter_signal_flag ) | |
| sao_max_offset_num | ue(v) |
| if( sao_luma_filter_signal_flag ) { | |
| sao_luma_num_filters_signalled_minus1 | ue(v) |
| for( sfIdx = 0; sfIdx <= | |
| sao_luma_num_filters_signalled_minus1; | |
| sfIdx++ ) | |
| sao_luma_type_idx [ sfIdx ] | u(1) |
| for( j = 0; j < sao_max_offset_num; j++ ) | |
| sao_luma_offset_abs[ sfIdx ][ j ] | ue(v) |
| if( sao_luma_type_idx[ sfIdx ] = = 1 ) { | |
| for( j = 0; j < sao_max_offset_num; j++ ) | |
| if( sao_luma_coeff_abs[ sfIdx ][ j ] ) | |
| sao_luma_offset_sign_flag[ sfIdx ][ j ] | u(1) |
| } | |
| } | |
| if( sao_chroma_cb_filter_signal_flag ) { | |
| sao_chroma_cb_num_filters_signalled_minus1 | ue(v) |
| for( sfIdx = 0; sfIdx <= | |
| sao_chroma_cb_num_filters_signalled_minus1; | |
| sfIdx++ ) | |
| sao_chroma_cb_type_idx [ sfIdx ] | u(1) |
| for( j = 0; j < sao_max_offset_num; j++ ) | |
| sao_chroma_cb_offset_abs[ sfIdx ][ j ] | ue(v) |
| if( sao_chroma_cb_type_idx[ sfIdx ] = = 1 ) { | |
| for( j = 0; j < sao_max_offset_num; j++ ) | |
| if( sao_chroma_cb_coeff_abs[ sfIdx ][ j ] ) | |
| sao_chroma_cb_offset_sign_flag[ | u(1) |
| sfIdx ][ j ] | |
| } | |
| } | |
| if( sao_chroma_cr_filter_signal_flag ) { | |
| sao_chroma_cr_num_filters_signalled_minus1 | ue(v) |
| for( sfIdx = 0; sfIdx <= | |
| sao_chroma_cr_num_filters_signalled_minus1; | |
| sfIdx++ ) | |
| sao_chroma_cr_type_idx [ sfIdx ] | u(1) |
| for( j = 0; j < sao_max_offset_num; j++ ) | |
| sao_chroma_cr_offset_abs[ sfIdx ][ j ] | ue(v) |
| if( sao_chroma_cr_type_idx[ sfIdx ] = = 1 ) { | |
| for( j = 0; j < sao_max_offset_num; j++ ) | |
| if( sao_chroma_cr_coeff_abs[ sfIdx ][ j ] ) | |
| sao_chroma_cb_offset_sign_flag[ | u(1) |
| sfIdx ][ j ] | |
| } | |
| } | |
| if( ccsao_ filter_signal_flag ) { | |
| sao_max_offset_num | ue(v) |
| ccsao_ num_filters_signalled_minus1 | ue(v) |
| for( sfIdx = 0; sfIdx <= | |
| ccsao_num_filters_signalled_minus1; sfIdx++ ) | |
| for( j = 0; j < ccsao_max_offset_num; j++ ) | |
| ccsao_offset_abs[ sfIdx ][ j ] | ue(v) |
| if( ccsao_coeff_abs[ sfIdx ][ j ] ) | |
| ccsao_offset_sign_flag[ sfIdx ][ j ] | u(1) |
| } | |
| } | |

### 5.3 Embodiment 3

### Sequence Parameter Set RBSP Syntax

| | Descriptor |
|---|---|
| seq_parameter_set_rbsp( ) { | |
| sps_sao_enabled_flag | u(1) |
| if( sps_sao_enabled_flag && | |
| sps_chroma_format_idc != 0 ) | |
| sps_ccsao_enabled_flag | u(1) |
| } | |

FIG. 23 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 24 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 25 is a flowchart for an example method 4200 of video processing. The method 4200 includes determining parameters for a sample adaptive offset (SAO) filter at step 4202. A conversion is performed between a visual media data and a bitstream based on the SAO filter at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

FIG. 26 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the HEVC standard, VVC standard and other current and/or further standards.

FIG. 27 is a block diagram illustrating an example of video encoder 4400, which may be video encoder 4314 in the system 4300 illustrated in FIG. 26. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current video block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

FIG. 28 is a block diagram illustrating an example of video decoder 4500 which may be video decoder 4324 in the system 4300 illustrated in FIG. 26. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

FIG. 29 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of embodiments discussed herein.

1. A method for processing video data comprising: determining parameters for a sample adaptive offset (SAO) filter; and performing a conversion between a visual media data and a bitstream based on the SAO filter.

2. The method of solution 1, wherein the SAO filter includes or is associated with a cross component SAO (CCSAO) filter.

3. The method of any of solutions 1-2, wherein the parameters for the SAO filter are predefined, derived adaptively, or included in the bitstream.

4. The method of any of solutions 1-3, wherein the parameters for the SAO filter are used for derivation of classification, or offsets for categories.

5. The method of any of solutions 1-4, wherein a syntax element is used to indicate which set is used for a video unit in the bitstream.

6. The method of any of solutions 1-5, wherein a number of predefined sets of parameters, a maximum number of predefined sets of parameters, a number of adaptive sets of parameters, or a maximum number of adaptive sets of parameters are included in the bitstream.

7. The method of any of solutions 1-6, wherein multiple offsets are derived from one or more sets of parameters, and wherein the multiple offsets are fused or selected and applied to a sample.

8. The method of any of solutions 1-7, wherein sets of parameters are included in an adaptation parameter set (APS) or a picture header.

9. The method of any of solutions 1-8, wherein a syntax element in a first APS indicates whether adaptive sets of the parameters for the SAO filter are included in the first APS.

10. The method of any of solutions 1-9, wherein a first parameter for the SAO filter is predicted by a second parameter for the SAO filter.

11. The method of any of solutions 1-10, wherein usage of the CCSAO filter depends on usage of the SAO filter.

12. The method of any of solutions 1-11, wherein the CCSAO filter is enabled for a component when the SAO filter is enabled for the component.

13. The method of any of solutions 1-12, wherein the CCSAO filter is disabled for a component when the SAO filter is disabled for the component.

14. The method of any of solutions 1-13, wherein usage of the CCSAO filter is dependent on color format.

15. The method of any of solutions 1-14, wherein the CCSAO filter is disabled when a 4:0:0 color format is used.

16. The method of any of solutions 1-15, wherein syntax elements for the CCSAO filter are inferred to be a predefined value.

17. The method of any of solutions 1-16, wherein determination of classification or determination of offsets is different for different color formats.

18. The method of any of solutions 1-17, wherein a number of categories, a minimum offset value, a maximum offset value, or a threshold used to determine a classification is different for different color formats.

19. The method of any of solutions 1-18, wherein chroma samples are used in an edge classifier for 4:2:2 or 4:4:4 color formats.

20. The method of any of solutions 1-19, wherein candidate positions of collocated luma samples are different for different color formats.

21. An apparatus for processing video data comprising: a processor; and a non-transitory memory with instructions thereon, wherein the instructions upon execution by the processor, cause the processor to perform the method of any of solutions 1-20.

22. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-20.

23. A non-transitory computer-readable recording medium storing a bitstream of a video which is generated by a method performed by a video processing apparatus, wherein the method comprises: determining parameters for a sample adaptive offset (SAO) filter; and generating the bitstream based on the determining.

24. A method for storing bitstream of a video comprising: determining parameters for a sample adaptive offset (SAO) filter; generating the bitstream based on the determining; and storing the bitstream in a non-transitory computer-readable recording medium.

25. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video data, comprising:
deriving, during a conversion between a video comprising a video unit and a bitstream of the video, parameters of a filter for the video unit from at least one predefined set and/or at least one adaptive set, wherein the filter comprises one of a sample adaptive offset (SAO) filter and a cross-component SAO (CCSAO) filter; and
performing the conversion based on the parameters of the filter.

2. The method of claim 1, wherein the parameters of the filter comprise parameters used for derivation of classification, and/or offsets for different categories.

3. The method of claim 1, wherein the adaptive set comprises parameters in a set which are derived adaptively or signalled explicitly in the bitstream.

4. The method of claim 1, wherein a syntax element signalled in the bitstream is used to indicate which set is used to derive the parameters of the filter for the video unit.

5. The method of claim 1, wherein at least one of: a number of the at least one predefined set, a maximum number of the at least one predefined set, a number of the at least one adaptive set, or a maximum number of the at least one adaptive set is signalled in the bitstream, is pre-defined, or is derived depending on coding information.

6. The method of claim 1, wherein the at least one adaptive set of parameters is signalled at a sequence level, a group of pictures level, a picture level, a slice level, or a tile group level.

7. The method of claim 1, wherein the at least one adaptive set of parameters is included in a sequence header, a picture header, a sequence parameter set (SPS), a video parameter set (VPS), a decoding parameter set (DPS), decoding capability information (DCI), a picture parameter set (PPS), an adaptation parameter set (APS), a slice header, or a tile group header.

8. The method of claim 6, wherein an adaptive set of parameters used for the SAO filter is included in an adaptation parameter set (APS) or a picture header, and
wherein an adaptive set of parameters used for the CCSAO filter is included in an adaptation parameter set (APS).

9. The method of claim 1, wherein a syntax element in a first adaptation parameter set (APS) is signaled to indicate whether an adaptive set of parameters for the SAO filter and/or the CCSAO filter is included in the first APS, wherein the syntax element is represented as aps_params_type.

10. The method of claim 1, wherein whether a syntax element indicating whether the CCSAO filter is enabled is signalled in the bitstream depends on a syntax element indicating whether the SAO filter is enabled.

11. The method of claim 1, wherein the CCSAO filter is disabled for a component when the SAO filter is disabled for the component.

12. The method of claim 1, wherein whether a syntax element indicating whether the CCSAO filter is enabled is signalled in the bitstream is dependent on a color format.

13. The method of claim 12, wherein the CCSAO filter is disabled when the color format is 4:0:0.

14. The method of claim 12, wherein the color format is 4:2:0, or 4:2:2, or 4:4:4.

15. The method of claim 2, wherein determination of the classification and/or the offsets is different for different color formats.

16. The method of claim 1, wherein the conversion includes encoding the video into the bitstream.

17. The method of claim 1, wherein the conversion includes decoding the video from the bitstream.

18. An apparatus for processing video data comprising: a processor and a non-transitory memory with instructions thereon, wherein the instructions upon execution by the processor, cause the processor to:
derive, during a conversion between a video comprising a video unit and a bitstream of the video, parameters of a filter for the video unit from at least one predefined set and/or at least one adaptive set, wherein the filter comprises one of a sample adaptive offset (SAO) filter and a cross-component SAO (CCSAO) filter; and
perform the conversion based on the parameters of the filter.

19. The apparatus of claim 18, wherein the parameters of the filter comprise parameters used for derivation of classification, and/or offsets for different categories,
wherein the adaptive set comprises parameters in a set which are derived adaptively or signalled explicitly in the bitstream,
wherein a syntax element signalled in the bitstream is used to indicate which set is used to derive the parameters of the filter for the video unit, and
wherein whether a syntax element indicating whether the CCSAO filter is enabled is signalled in the bitstream depends on a syntax element indicating whether the SAO filter is enabled and a color format.

20. A non-transitory computer-readable recording medium storing a bitstream of a video which is generated by a method performed by a video processing apparatus, wherein the method comprises:
deriving, for the video comprising a video unit, parameters of a filter for the video unit from at least one predefined set and/or at least one adaptive set, wherein the filter comprises one of a sample adaptive offset (SAO) filter and a cross-component SAO (CCSAO) filter; and
generating the bitstream based on the parameters of the filter.
